(19) United States
(12) Patent Application Publication
(10) Pub. No.: US 2004/0076414 A1
(43) Pub. Date: Apr. 22, 2004

(54) Photography print system and method of controlling the same

(76) Inventors: Katsuyuki Inage, Kyoto (JP); Tetsuya Miwa, Kyoto (JP); Hajime Nishidai, Kyoto (JP); Eiji Kuroda, Osaka (JP); Masamichi Akima, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/647,590

(22) Filed: Aug. 26, 2003

(30) Foreign Application Priority Data
Feb. 3, 2003 (JP) 2003-026439
Aug. 30, 2002 (JP) 2002-255164

(51) Int. Cl. G03B 15/00

(52) U.S. Cl. 396/2

(57) ABSTRACT

A photographic apparatus, system and related method is disclosed to prevent overexposure at the time of upper-body photography. Strobe lights are incorporated in the photographic system, where the strobe lamps are offset from a directional line leading from the photographic apparatus to the user. The lights are activated in a sequence to minimize the incidence of shading. A photograph print system associated with the photographic system includes a photographic device for capturing a photograph of a user. An image output device forms an image on the basis of the photograph for output to a print sheet.

The present invention is generally related to photography print systems. An exemplary embodiment of the present invention performs editing processing on an acquired image and issues an output to a print sheet, such as seal sheets or the like, on the basis of the edited image. An exemplary method is also disclosed, along with a control program, a recording medium, on which the program is recorded, and a print sheet unit.

### BACKGROUND OF THE INVENTION

Conventionally, photograph seal automatic vending machines are installed in facilities such as game centers or the like to take a photograph of a user to combine a photographed image, with a background image or the like to output the combined images as seal prints. Generally, a photograph flash light such as a strobe lamp is provided at least in the vicinity of a photographic camera, which takes a photograph of a user. The photographic flash light irradiates light on a user at the time in which a photographic picture is being taken, and the reflected light is incident upon the photographic camera, wherein a photographed image is acquired.

Photographically sealed automatic vending machines also include a machine having both functions of upper-body photography (i.e., close-up photography), in which a part of a user's body is photographed in a size to be contained in a screen, and whole-body photography (i.e., full-size photography), in which a user's whole body is photographed in a size to be contained in a screen.

When upper-body photography is performed, many users approach a photographic camera too closely, even when the photographic camera possesses a zooming function. In this case, users standing too close to a camera will have excess light irradiated them from the photograph flash and result in overexposure.

### BRIEF SUMMARY OF THE INVENTION

One aspect of the invention provides a photograph print system for preventing overexposure at the time of upper-body photography. Under exemplary embodiments detailed below, various photograph print systems and related methods are discussed that include a photographic apparatus for photographing a subject, an image output apparatus for forming an image on the basis of a photograph to output the same to a print sheet, and an illumination apparatus for illuminating the subject, wherein the illumination apparatus sets a direction of illumination to be offset from a direction toward the subject.

Since the direction of illumination of the illumination apparatus is offset from a direction toward the subject, a quantity of light irradiated directly on the subject from the illumination apparatus decreases while a quantity of light reflected by other members and irradiated indirectly on the subject from the illumination apparatus increases. In this case, even when the subject physically approaches the photographic apparatus to thereby reduce a distance between the subject and the illumination apparatus, a quantity of light irradiated directly on the subject from the illumination apparatus is smaller, so that it is possible to suppress an increase in the quantity of light irradiated on the subject. Accordingly, even when the subject approaches the photographic apparatus, it is possible to suppress an increase in intensity of illumination on the subject, and so it is possible to prevent overexposure.

Furthermore, another exemplary embodiment of the invention includes a reflection apparatus provided laterally of a photography space, in which photography is performed, to reflect light from the illumination apparatus.

With the above constitution, light from the illumination apparatus is reflected by the reflection apparatus provided laterally of the photographic space. Accordingly, when a quantity of light irradiated directly on the subject from the illumination apparatus decreases, a quantity of light reflected by the reflection apparatus and irradiated indirectly on the subject from the illumination apparatus increases. Under this configuration, a decrease in intensity of illumination on the subject may be prevented by offsetting the direction of illumination towards the subject from the illumination apparatus.

In combining a photographed image with a background image, a chromakey composition is generally used, in which a background region of the photographed image is colored (e.g., white, blue, or the like) whereby the background region of the photographed image and a subject region are easily separated from each other and the separated subject region is combined with the background image. In order to make a background portion of the photographed image of a particular color, a background curtain, a background plate, or the like, of the particular color is arranged behind the subject.

In conventional arrangements where the illumination apparatus irradiates light toward the subject, a shadow of the subject is also reflected in the background curtain of a photographed image, and a shadow of the subject is reflected in the background as well. Under such conditions, the background region of the photographed image becomes uneven in terms of brightness and a background region of an image formed by combining the photographed image with a background image becomes uneven.

In contrast, an embodiment of the present invention is configured in such a way that light from the illumination apparatus is reflected by the reflection apparatus, provided laterally of the photographic space, to thereby detour the subject to be able to reach a background curtain behind the subject. Accordingly, a shadow of the subject can be prevented from being reflected in the background curtain, and the background region of the photographed image becomes even in brightness, so that the combination of the photographed image and a background image can be made with accuracy.

Further, yet another embodiment of the invention provides a photograph print system, wherein the reflection apparatus utilizes a light reflection coefficient from a position close to the illumination apparatus to a position close to a preferable subject position in the case where the photographic apparatus performs near-by photography.

Generally, light from the illumination apparatus is mainly irradiated directly on a front surface of a subject and a reflected light, which light from the illumination apparatus is reflected by the reflection apparatus provided laterally of the photographic space to generate, is mainly irradiated on the sides of the subject. Also, in order to photograph the subject evenly, a soft light from the illumination apparatus is irradiated in such a manner that the subject is made uniform in brightness. Meanwhile, in near-by photography, a photographed image with a three-dimensional effect, which is produced by shade, is acquired.

Under this configuration, the reflection apparatus maintains a small light reflection coefficient from a position close to the illumination apparatus to a position close to a preferable subject position in the case where near-by photography is performed. Therefore, with near-by photography, light, which is reflected by the reflection apparatus to be irradiated on sides of the subject decreases in quantity. Since light irradiated on the sides of the subject is made smaller in quantity than light irradiated on a front surface of the subject, a shadow is generated on the subject with the result that it is possible to acquire a photographed image with a three-dimensional effect.

Furthermore, an auxiliary illumination apparatus is provided for illuminating a part of a subject so as to erase an unnecessary shade generated on the subject by illumination of the illumination apparatus in the case where the near-by photography is performed. As described above, when light irradiated on the sides of the subject is made smaller in quantity than light irradiated on a front surface of the subject, a shadow is generated on the subject. Under such conditions, undesired shadows, such as a shadow of the chin of the user, are produced.

To minimize or eliminate such shadows, the auxiliary illumination apparatus illuminates a part of a subject whereby the undesired shadow can be erased The results are particularly advantageous when a photographic subject stays in a specific position illuminated by the auxiliary illumination apparatus. When the auxiliary illumination apparatus is arranged to illuminate a subject present in a position suited for photography, it is possible to prevent a user from approaching the photographic apparatus, thereby minimizing or eliminating the incidents of overexposure.

A photograph print system is also disclosed, wherein the print system includes a photographic apparatus for taking a photograph of a user, and image output apparatus for forming an image on the basis of the photography and outputting the same to a print sheet. An operation apparatus is provided in the vicinity of a subject position to enable a user to operate the photographic apparatus. Under this configuration, when the photographic apparatus is operated to perform photography, a user should preferably stay in a position in which the operation apparatus is present (i.e., in the vicinity of a subject position suited for photography). Accordingly, it is possible to prevent a user from approaching the photographic apparatus, thereby preventing overexposure.

A photograph print system is also disclosed, which comprises a photographic apparatus for photographing a subject, and an image output apparatus for forming an image on the basis of the photography to output the same to a print sheet. The photographic apparatus is preferably arranged to be able to move toward the subject. In this case, when the photographic apparatus is moved toward the subject (i.e., where it is desired that the subject approach the photographic apparatus), the subject will not be excessively close to the illumination apparatus, even when the subject approaches the photographic apparatus too closely. Accordingly, the intensity of illumination on the subject will not be excessively increased so that overexposure can be prevented.

A movement detection apparatus is also disclosed for detecting movements of the photographic apparatus. In cases where a user of the photograph print system does not notice that the photographic apparatus is movable, or hesitates to move the photographic apparatus, it is possible by way of voice output through speakers and/or image output on a display to inform a user that the photographic apparatus is movable. Alternately, the user may be informed to move the photographic apparatus when the movement detection apparatus does not detect movement of the photographic apparatus.

Optional sensors may also be used in the movement detection apparatus, such as vibration sensors, acceleration sensors, or the like, to detect movements of the photographic apparatus. A drive apparatus, such as motors or the like, may be used for moving the photographic apparatus. The operation apparatus may be configured along with the movement detection apparatus to control the drive apparatus to allow a user to physically move the photographic apparatus. In this manner, the movement detection apparatus may directly or indirectly detect movements of the photographic apparatus.

For detecting these movements, a travel detection apparatus may be used to detect a travel of the photographic apparatus. Under this configuration, the travel detection apparatus can detect a travel of the photographic apparatus, and inform a user by way of voice output and image output on a display of a travel and the remaining possible travel. Also, an optimum quantity of light conformed to a travel of the photographic apparatus can be set by adjusting a quantity of light of the illumination device for photography, such as strobe lamps or the like, for taking a photograph on the basis of a travel of the photographic apparatus detected by the travel detection apparatus. In this manner, a user may use this information to optimally set the photographic apparatus.

In addition, the travel detection apparatus may include acceleration sensors, and rotary encoders. Also, in the case where the photograph print system comprises a motor for moving the photographic apparatus and the motor houses therein an encoder, the encoder can be used as the travel detection apparatus.

Furthermore, a photographed image display apparatus is disclosed for displaying a photographed image, as well as a digital zooming apparatus for performing digital zooming processing for enlargement and/or reduction of the photographed image on the basis of the travel detected by the travel detection apparatus. The photographed image display apparatus displays, as a photographed image, an image having been subjected to digital zooming processing by the digital zooming apparatus. In some cases, using the photographic apparatus exclusively to make enlarged photography or reduced photography of a subject will be insufficient because of a small possible travel of the photographic apparatus. Accordingly, the digital zooming apparatus performs a digital zooming processing of a photographed image on the basis of a travel of the photographic apparatus and provides an image for display on the photographed image display apparatus. Thereby, the digital zooming processing can perform sufficient enlarged photographing or reduced photographing of a subject. An image having been subjected to the digital zooming processing is accordingly displayed on the photographed image display apparatus whereby a user can perform photography at an appropriate magnification while seeing an image displayed on the photographed image display apparatus.

Also, another exemplary embodiment of the invention provides a photograph print system comprising a photographic apparatus for taking a photograph of a subject, and an image output apparatus for forming an image on the basis of the photography to output the same to a print sheet. The photographic apparatus includes an optical zooming function, a photographed image display for displaying a photographed image, and a digital zooming apparatus for performing a digital zooming processing for enlargement and/or reduction of the photographed image on the basis of a multiplying factor provided by the optical zooming function of the photographic apparatus. The photographed image display shows the image after having been subjected to the digital zooming processing by the digital zooming apparatus.

Under this configuration, the digital zooming apparatus performs digital zooming processing of a photographic image on the basis of a multiplying factor provided by the optical zooming function of the photographic apparatus, and the processed image is displayed on the photographed image display means. Accordingly, the digital zooming processing produces enlarged or reduced photographs of a subject, which are of a better quality as compared to photographs that rely only on optical zooming of the photographic apparatus. The digitally processed image is also displayed on the photographed image display apparatus whereby a user can perform photography at an appropriate magnification while seeing an image displayed on the photographed image display.

The digital zooming feature further performs a processing function of enlarging a central portion of the photographed image while reducing a surrounding portion thereof, or alternately reducing a central portion thereof and enlarging a surrounding portion. Under this configuration, when a subject is disposed in a central portion of a photographed image, it is possible to acquire an image in which the subject is appropriately enlarged or reduced and a background is purposefully distorted.

A method of controlling a photograph print system is also disclosed, wherein a movable photographic apparatus photographs subject, while an image output apparatus forms an image on the basis of the photograph to output the same to a print sheet. A movement detection apparatus detects movements of the photographing apparatus, and provides information to a user, wherein the information is controlled to alert the user that the photographing apparatus can be moved in cases where the movement detection means does not detect movements of the photographing means for a predetermined period of time. Optional means, such as displays, speakers, or the like, can be used to communicate the information.

Using the above method, control is performed so that the information providing apparatus informs a user that the photographing apparatus can be moved. The apparatus may then be moved automatically, or may be manually moved by the user.

Also, a method for controlling a photograph print system is disclosed, wherein a moveable photographing apparatus photographs a subject, and an image output apparatus forms an image on the basis of the photograph to output the same to a print sheet. A travel detection apparatus detects a travel of the photographing apparatus, while the photographed image is subjected to digital zoom processing for enlargement and/or reduction of the photographed image on the basis of the travel detected by the travel detection means The photographed image subjected to digital zoom processing is then displayed on the photographed image display apparatus. Control is performed such that a digital zoom processing for enlargement and/or reduction of a photographed image is based on the travel detected by the travel detection means.

Further, a method for controlling a photograph print system, wherein an exemplary digital zooming process includes a processing step for enlarging a central portion on a photographic image and reducing a surrounding portion thereof in the case where the photographic apparatus is moved to a neighborhood of a position closest to the subject. Next, a processing step for of reducing a central portion of the photographic image is performed to enlarge a surrounding portion thereof in the case where the photographic apparatus is moved to a neighborhood of a position most distant from the subject. Finally, a processing step for enlarging or reducing the photographed image at an equal magnification is performed for other cases.

Using the above method, an image being different in multiplying factors between a central portion and a surrounding portion can be acquired and a purposefully distorted image can be produced. The method is particularly effective in cases where the photographic apparatus is moved to a neighborhood of a position closest to or most distant from the subject, that is, a neighborhood of limits of movements of the photographic apparatus. Also, an image being of the same multiplying factor between a central portion and a surrounding portion can be acquired and a correct enlarged or reduced image can be produced in the case where the photographic apparatus is moved to other positions. Accordingly, both a correct photographed image and a purposefully distorted photographed image can be presented to a user.

A method of controlling a photograph print system is also disclosed, which includes a digital zooming process for enlargement and/or reduction of the photographed image on the basis of a multiplying factor provided by the optical zooming function of the photographic apparatus, and displaying an image having been subjected to the digital zooming processing on the photographed image display apparatus.

Accordingly, the digital zooming processing can compensate for enlarged photography or reduced photography of a subject. Also, an image having been subjected to the digital zooming processing is displayed on a photographed image display whereby a user can perform photography at an appropriate magnification while seeing an image displayed on the photographed image display apparatus.

Further, a method is also disclosed for controlling a photograph print system, wherein the digital zooming processing comprises a step of performing a process for enlarging a central portion of a photographic image and reducing a surrounding portion thereof in the case where the multiplying factor provided by the optical zooming function of the photographic apparatus reaches a substantially maximum value. Further processing can reduce a central portion of the photographic image while enlarging a surrounding portion thereof in the case where the multiplying factor reaches a substantially minimum value. Additional processing can enlarge or reduce the photographed image at an equal magnification in other cases.

Using the above method, an image being different in multiplying factor between a central portion thereof and a surrounding portion thereof can be acquired and a purposefully distorted image can be acquired in the case where the multiplying factor provided by the optical zooming function of the photographic apparatus reaches a substantially maximum or minimum value. The value may be changed under an exemplary embodiment by moving the photographic apparatus to a neighborhood of limits of the multiplying factor. Also, an image being of the same in multiplying factor between a central portion and a surrounding portion thereof can be acquired and a correct enlarged or reduced image can be acquired in the case where the photographic apparatus is moved to other positions. Accordingly, both a correct photographed image and an interesting photographed image can be presented to a user.

In addition, the method of controlling a photograph print system can be executed as a control program of a photograph print system by a computer. Further, the control program of a photograph print system is recorded in a computer-readable recording medium, whereby the method of controlling a photograph print system can be executed on an optional computer.

Also, the invention provides a print sheet unit used in the photograph print system, comprising print sheets and an identification medium, on which identification information with respect to the print sheets is recorded. Identification information recorded on the identification medium is read by an identification information reading apparatus, which is provided in the photograph print system, and an image is output to the print sheets after contents of the identification information is confirmed.

Using the above method, the identification information read by the identification information reading apparatus determines whether print sheets as charged are available in a photograph print system, and a printer is made actuatable only in the case of being available. Settings may be adjusted so that print sheets, other than those specified in a photograph print system, cannot be used.

Also, by containing information of the number of sheets in the identification information, the number of the remainder of sheets can be recorded by counting down the number of sheets every use of sheets. Therefore, by alarming via display means when the number of the remainder of sheets becomes small, it is possible to avoid a disadvantage that sheets run out during the use by a user. Also, by containing information of kinds of sheets in the identification information, images can be correctly output to sheets and ink film by correcting color components of an image data in view of the identification information.

These and other features and advantages of the invention will be more clearly seen from the following detailed description of the invention which is provided in connection with the accompanying drawings.

### BRIEF DESCRIPTION OF THE DRAWINGS

FIG. 1 is a plan view showing a direction, in which light from an illumination device advances, in a photograph print system according to an exemplary embodiment of the invention;

FIG. 2 is a perspective view showing an internal view of the photograph print system and specifically showing an outward appearance of a back surface of a body apparatus;

FIG. 3 is a side view showing another internal view of the photograph print system;

FIG. 4 is a perspective view showing an outward appearance of a front surface of a body apparatus;

FIG. 5 is an exploded view showing an upper-body photographic apparatus in the body apparatus and a storage portion thereof;

FIG. 6 is a block diagram illustrating a schematic embodiment of the photograph print system;

FIG. 7 is a flowchart illustrating an exemplary processing flow in the photograph print system;

FIGS. 8A to 8E are views showing changes of a live view image displayed on a LCD, relative to a camera position in the photograph print system;

FIGS. 9A to 9E are views showing changes of a live view image displayed on a LCD, relative to a camera position in a photograph print system according to another exemplary embodiment of the invention;

FIG. 10 is a graph showing exemplary changes in digital zooming multiplying factor in the photograph print system;

FIG. 11 is a flowchart illustrating exemplary operations in photographic processing in the photograph print system;

FIG. 12 is a flowchart illustrating operations in photographic processing in the photograph print system;

FIG. 13 is a flowchart illustrating operations in digital zooming processing of a photographed image illustrated in FIGS. 11 and 12;

FIG. 14 is a graph showing another example of changes in digital zooming multiplying factor, relative to a camera position in the photograph print system; and

FIG. 15 is a graph showing a further example of changes in digital zooming multiplying factor, relative to a camera position in the photograph print system.

### DETAILED DESCRIPTION OF THE INVENTION

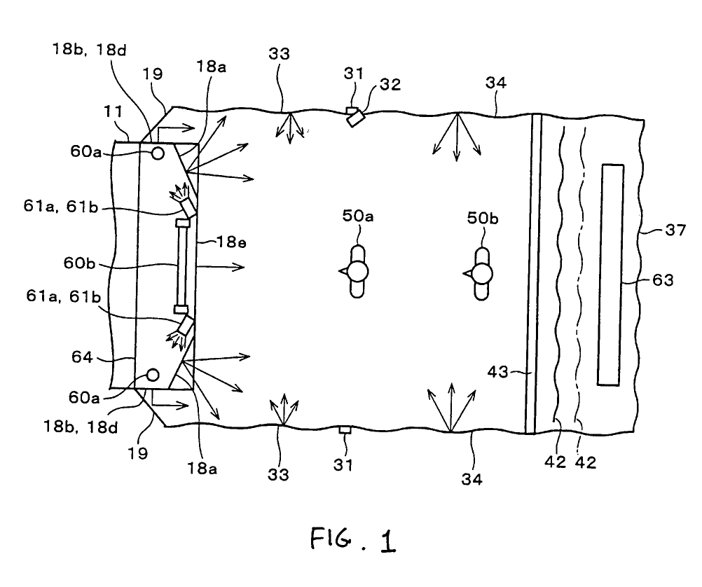

An explanation will be given as follows to an exemplary embodiment of the invention with reference to FIGS. 1 to 8. FIG. 1 shows an exemplary photography space, in which photography is performed, wherein a photographic print system 10 is arranged therein.

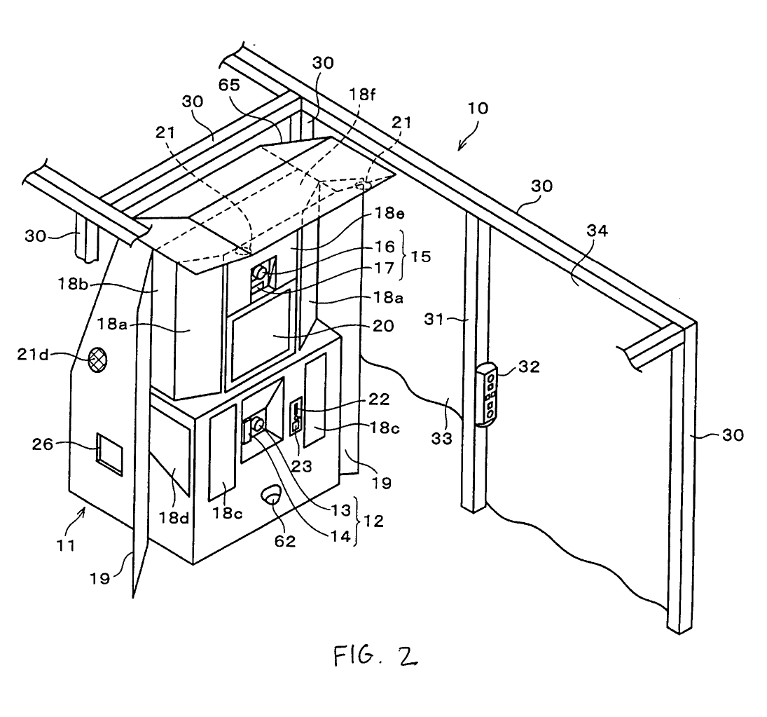

The photograph print system 10 comprises a body apparatus 11 provided with photographic apparatuses (photographic apparatus) 15, 12 (see FIG. 2), by which users 50a, 50b (see FIG. 3) are photographed as subjects, and a background apparatus 40 for defining a background of the subjects. A surrounding and an upper portion, which extend from the body apparatus 11 to the background apparatus 40, are covered with shield curtains 33, 34, 37, which define the photographic space. In addition, the side on which the body apparatus 11 is arranged will hereinafter be referred to as “front side”, and the side on which the background apparatus 40 is arranged will hereinafter be referred to as “rear side”. Also, users are described as “user 50” when being referred to generically.

The body apparatus 11 comprises, in addition to the photographic apparatuses 12, 15, fluorescent lamps 60a, 60b functioning as illumination apparatuses for illuminating the user 50 as a subject, strobe lamps 61a, 61b, a reflection wall 64, and scattering transmission plates 18a to 18e. In addition, the fluorescent lamps will be described as “fluorescent lamp 60”, strobe lamps will be described as “strobe lamp 61”, and scattering transmission plates will be described as “scattering transmission plate 18” for the purposes of simplicity.

The fluorescent lamp 60 functions as an illumination source at the time of photography and also ordinarily functions as illumination for the photographic space. Specifically, the fluorescent lamp 60 ensures a quantity of light for a live view photographed by the photographic apparatuses 12, 15 at the time of photography. Additionally, fluorescent lamp 60 makes use of illumination to present a photographic space such that an impression is given to the user 50 (e.g., “it is likely that a pretty photograph is taken”). The fluorescent lamps 60a, 60a, respectively, are arranged on both sides in the body apparatus 11, the fluorescent lamp 60b being arranged in an upper portion of the body apparatus 11

The strobe lamp 61 functions as a photography flash lamp at the time a photograph is taken and are arranged on both sides of the photographic apparatuses 12, 15 in the body apparatus 11. According to the embodiment, since the arrangement of the two photographic apparatuses 15, 12 for upper-body photography and for whole-body photography are arranged as photographic apparatuses, the strobe lamps 61a, 61a are arranged on both sides of the upper-body photographic apparatus 15, and the strobe lamps 61b, 61b are arranged on both sides of the whole-body photographic apparatus 12.

The strobe lamp 61 is arranged forward and outward in a manner to make illumination focused toward the fluorescent lamp 60a. Light from the strobe lamp 61 is directed toward the fluorescent lamp 60a by means of the reflection plates provided on both sides thereof.

The reflection wall 64 is arranged in front of the fluorescent lamp 60 and the strobe lamp 61. Light irradiated from the fluorescent lamp 60 and the strobe lamp 61 is reflected rearward by the reflection wall 64. Light irradiated from the fluorescent lamp 60 and the strobe lamp 61, and light reflected by the reflection wall 64, are subjected to scattering by the scattering transmission plates 18 and are further irradiated into the photographic space. The scattering transmission plates 18 are arranged on a back-surface portion and side-surface portions of the body apparatus 11.

A major portion of light irradiated from the upper strobe lamps 61a, 61a is reflected by the reflection wall 64 and is then subjected to scattering transmission by scattering transmission plates 18a, 18b which are arranged to extend from central portions on both sides of the rear-surface portion to upper portions thereof The light from the scattering transmission plates 18a, 18b are then irradiated into the photographic space.

It should be noted that the scattering transmission plates 18a, 18a are arranged such that their normal directions are offset from a direction toward the user 50, that is, rearward and outward. Accordingly, light transmitted through the scattering transmission plates 18a, 18a is irradiated rearward and outward, so that a quantity of light irradiated directly on the user 50 decreases and a quantity of light reflected by the shield curtains 33, 34 which is irradiated indirectly on the user 50, increases.

In this case, when the user 50a is attempting to engage in upper-body photography approaches the photographic apparatus 15, and a distance between the user 50a and the scattering transmission plates 18a, 18a becomes small, an increase in quantity of light irradiated on the user 50a can be suppressed, since a quantity of light irradiated directly on the user 50a from the scattering transmission plates 18a, 18a is reduced. Accordingly, even when the user 50a approaches the photographic apparatus 15 too closely, an increase in intensity of illumination on the user 50a can be suppressed and so overexposure can be prevented.

Reflective curtains 19, 19 are arranged on both side portions of the body apparatus 11. The respective reflective curtains 19, 19 are arranged obliquely so as to reflect the outwardly directed light, which has been subjected to scattering by the scattering transmission plates 18b, 18d on side portions, to make the same rearwardly directed light. Thereby, a quantity of light irradiated indirectly on the user 50 can be increased.

In cases where the photograph print system is installed in a shop such as game centers or the like, it is preferable that a width of the photograph print system be as small as possible in order to make effective use of a space in the shop. Using this configuration, an illumination effect can be produced that is comparable to a body apparatus having a large emission surface, (e.g., a large width) since an emission surface for irradiation on the photographic space rearwardly of the body apparatus 11 is enlarged up to the reflective curtains 19, 19 arranged on both side portions of the body apparatus 11 from the rear-surface portion of the conventional body apparatus 11.

Additionally, the reflective curtains 19, 19 can be made of an optional material such as metal, resin materials, curtain materials, or the like, provided that such material possesses a light reflective property. Also, plate-shaped reflection members can be used in place of the reflective curtains 19, 19.

The shield curtains 33, 34, 37 are preferably composed of a vinyl sheet having a shield property to prevent outside light from entering the photographic space. The provision of the shield curtains 33, 34, 37 makes it possible to take a more favorable photography, and presentation produced by illumination and voice is made effective during photographic processing.

Still referring to FIG. 1, struts 31, 31 are arranged on both sides close to a subject position suited to upper-body photography of the user 50. Remote manipulators (operating means) 32, with which the user 50 performs various operations in photography, are arranged in position on the right strut 31. Under the exemplary embodiment, operations performed by the remote manipulators 32 include selective operations of the number of photographs and a photographic time, selection of a background in the background apparatus 40, and operation of the start of photography. Since the remote manipulators 32 are arranged in the vicinity of a subject position suited for upper-body photography, the user 50 will stay in a position, in which the remote manipulators 32 are present(i.e., in the vicinity of a position suited to upper-body photography), when photography is performed. Accordingly, it is possible to prevent the user 50 from approaching the photographic apparatus 15 so much as to prevent overexposure.

The shield curtains 34, 34 positioned rearwardly of the struts 31, 31 are colored, for example, white with a high reflection coefficient. Thereby, the insides of the shield curtains 34, 34 function as a reflection apparatus for reflecting light from the scattering transmission plates 18. Accordingly, it is possible to irradiate light of a sufficient quantity on the user 50 and the background apparatus 40. Also, as a quantity of light irradiated from sides increases, the intensity of illumination on the front surface and on the sides can be made uniform for the user 50b who intends to engage in whole-body photography and a photographic position of whom is rearwardly of the struts 31, 31. Thereby, it is possible to illuminate the user 50b with uniform brightness to acquire photographs of the user 50b with less shadow.

Light reflected by the insides of the shield curtains 34, 34 in FIG. 1 detours the user 50 to be able to reach a background body 42. Thereby, the background body 42 can be made uniform in intensity of illumination, so that a background region of a photographed image will be made of a more uniform brightness in cases where photography is performed with the background body 42 colored in a particular color. Accordingly, it is possible to accurately separate a background region of a photographed image and a subject region from each other to accurately make a composition of the subject region and the background region.

A doorway for the user 50 extends from the body apparatus 11 to the struts 31, 31. Accordingly, it is desired that the shield curtains 33, 33 arranged to extend from the body apparatus 11 to the struts 31, 31 be mounted to curtain rails, or enabled to be wound up with only upper ends thereof fixed, to be thereby openable. In addition, lower portions of the shield curtains 33, 33 are alternately made to be opened as well. It is noted that, unlike the shield curtains 34, 34 disposed rearwardly of the struts 31, 31, the insides of the shield curtains 33, 33 disposed forwardly of the struts 31, 31 are colored, for example, black or other similar colors with a low reflection coefficient. Thereby, a quantity of light reflected by the shield curtains 33, 33 decreases. In this case, the intensity of illumination on the sides becomes lower than that on the front surface, since a quantity of light from the sides is suppressed for the user 50a who is subjected to upper-body photography. A photographic position is disposed close to and between the struts 31, 31, or alternately forward of the struts 31, 31. Accordingly, it is possible to acquire a photographed image of the user 50a with more shadow and a three-dimensional effect.

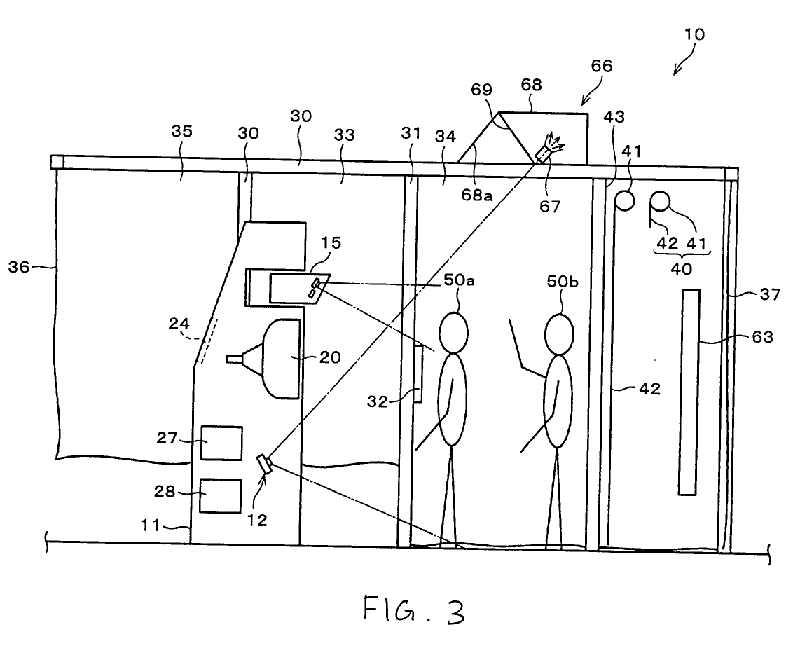

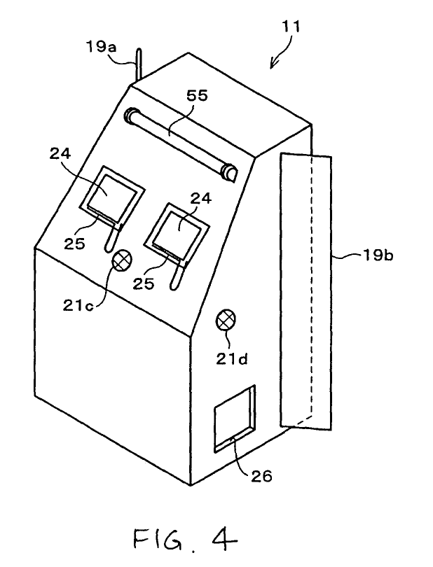

Additional exemplary embodiments of the photograph print system 10 will now be described with reference to FIGS. 2 to 5. FIGS. 2 and 3 show schematic illustrations of the photograph print system 10. FIG. 2 specifically shows an outward appearance of a back side of the body apparatus 11. Also, FIG. 4 illustrates an outward appearance of a front side of the body apparatus 11.

With reference to the body apparatus 11 of FIGS. 2 and 3, the whole-body photographic apparatus 12 is arranged on a back surface portion. The upper-body photographic apparatus 15, the scattering transmission plates 18a, 18c, 18e, a display 20, a coin slot 22, a coin return port 23, and a spot light 62, are arranged as shown in FIG. 2. Also, arranged on an upper-surface portion of the body apparatus 11 are the scattering transmission plate 18f, a reflector 65, and speakers 21, 21.

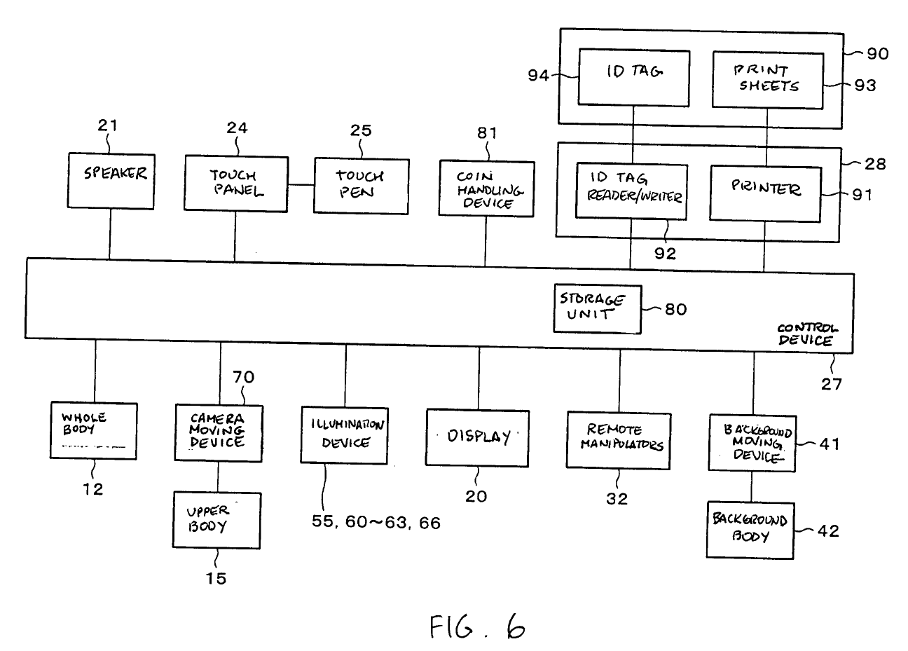

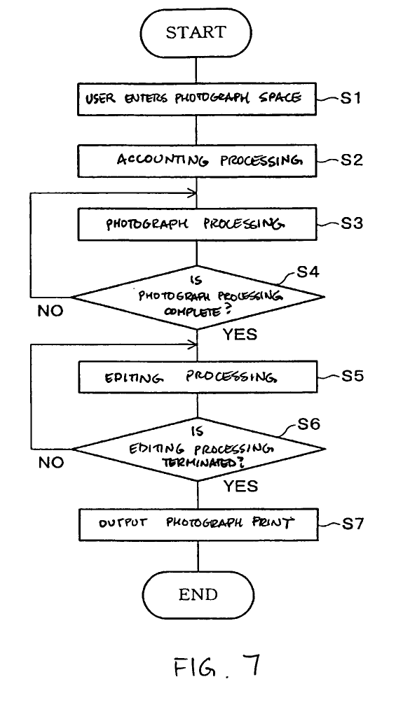

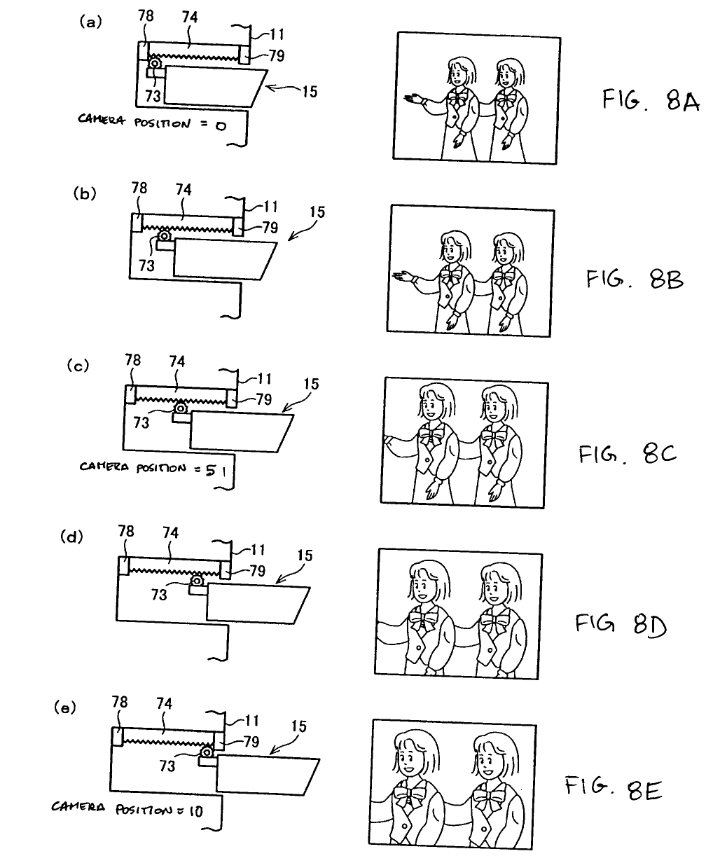

Additionally, a speaker 21c, touch panels 24, 24, touch pens 25, 25, and an illumination device 55, are arranged on a front surface portion of the body apparatus 11 as shown in FIG. 3. The scattering transmission plates 18b, 18d, the reflective curtains 19, 19, a speaker 21d, and a print discharge port 26 are arranged on the sides of body apparatus 11. Control device 27, a print output device 28, a coin handling device 81, and a print sheet unit 90 are arranged in the body apparatus 11, as shown in FIGS. 3 and 6.

Arranged centrally of the back-surface portion of the body apparatus 11 is a display 20 for displaying various images. The display 20 comprises a CRT (Cathode Ray Tube), or a flat panel display such as LCD (Liquid Crystal Display) or the like. The whole-body photographic apparatus 12 is arranged below the display 20, for whole-body photography of the user 50 as a subject, and arranged above the display 20 is the upper-body photography apparatus 15 for upper-body photography of the user. The whole-body photographic apparatus 12 comprises a camera 13 for photography, and a LCD (Liquid Crystal Display) 14 for displaying a live view image photographed by the camera 13. The camera 13 preferably comprises a digital camera provided with, for example, a group of lenses, a diaphragm, CCD (Charge Coupled Device) imagers, and is arranged upwardly and obliquely so as to be able to photograph a whole body of the user 50. The LCD 14 is arranged upwardly and obliquely so as to enable the user to confirm a display screen.

The upper-body photographic apparatus 15 preferably comprises a camera 16 for photography, and a LCD 17 for displaying a live view image photographed by the camera 16. The camera 16 comprises a digital camera provided with, for example, a group of lenses, a diaphragm, CCD imagers, and is arranged downwardly and obliquely so as to be able to photograph a part (in particular, an upper body of a user), and the LCD 17 is arranged similarly so as to enable the user to confirm a display screen.

The upper-body photographic apparatus 15 is also arranged to be movable rearward from the body apparatus 11. In this case, when the upper-body photographic apparatus 15 is moved rearward when the user 50a desires to approach the upper-body photographic apparatus 15, the user 50a will not be too close to the fluorescent lamps 60a, 60b and the strobe lamps 61a, 61b. Accordingly, the intensity of illumination on the user 50a is not increased excessively, so that it is possible to prevent overexposure.

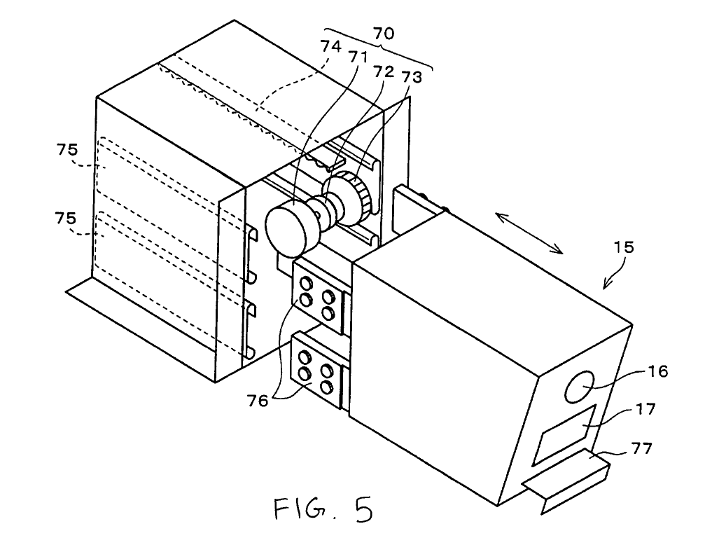

FIG. 5 shows details of the upper-body photographic apparatus 15 and a storage portion of the body apparatus 11 for the upper-body photographic apparatus 15. The upper-body photographic apparatus 15 comprises a housing, on a back-surface portion of which are provided the camera 16 and the LCD 17. Arranged in the housing are various devices for actuating the camera 16 and the LCD 17. Also, a handle 77, with which the user 50 moves the upper-body photographic apparatus 15, is provided on a lower side of the back-surface portion of the housing.

A motor 71 is provided on a projection, which projects centrally from a front portion of the housing of the upper-body photographic apparatus 15. A pinion 73 is mounted on a rotating shaft of the motor 71 with an electromagnetic clutch 72 therebetween. Also, sliders 76, are provided to extend from both sides of the front portion of the housing.

A rack 74 is arranged in the storage portion of the body apparatus 11 for the upper-body photographic apparatus 15, wherein the rack serves to mesh with the pinion 73 of the upper-body photographic apparatus 15, and rails 75, on which the sliders 76, of the upper-body photographic apparatus 15 slide. In addition, the motor 71, the electromagnetic clutch 72, the pinion 73, and the rack 74 function as a camera moving device 70 for longitudinally moving the upper-body photographic apparatus 15.

Under this configuration, when the electromagnetic clutch 72 does not connect the motor 71 and the pinion 73 to each other, the user 50 can use the handle 77 to manually move the upper-body photographic apparatus 15 longitudinally. The user 50 can operate the remote manipulators 32 to drive the motor 71, thereby enabling the upper-body photographic apparatus 15 to move longitudinally.

When the upper-body photographic apparatus 15 is manually moved with the use of the handle 77, the user 50a can actually feel that the upper-body photographic apparatus 15 is movable longitudinally, and can efficiently perform photography after the next photography because of being able to cause movements of the upper-body photographic apparatus 15. Meanwhile, when the motor 71 is driven to automatically move the upper-body photographic apparatus 15, the user 50a is relieved of labor.

FIGS. 8A to 8E illustrate how an exemplary live view image displayed on the LCD 17 is varied, depending upon a position (referred to as “camera position”) of the upper-body photographic apparatus 15 relative to the body apparatus 11. The left portion of the figure illustrates the positional relationship between the storage portion of the body apparatus 11 and the upper-body photographic apparatus 15. The right portion of the figure is a live view image displayed on the LCD 17 in cases where the upper-body photographic apparatus 15 is moved to a camera position in the leftward portion of the figure.

FIG. 8A also shows a state, in which the upper-body photographic apparatus 15 is stored to the maximum in the body apparatus 11. A camera position x in this state is assumed to be at an initial state, set to a value of 0. In contrast, FIG. 8E shows a state, in which the upper-body photographic apparatus 15 projects to the maximum from the body apparatus 11. A camera position x in this state is set to a maximum state, set to a value of 10. FIGS. 8B to 8D show states, in which the upper-body photographic apparatus 15 is moved from the initial state in FIG. 8A to the maximum state in FIG. 8E. FIG. 8C shows a state set approximately in the middle between the state in FIG. 8A and the state in FIG. 8E. In FIG. 8C, the camera position x in this state corresponds to value of 5.

Referring to FIGS. 8A to 8E, it can be understood that as a camera position x increases, that is, as the upper-body photographic apparatus 15 approaches the user 50, the user 50 is photographed in an enlarged state. Accordingly, a photographed image can be adjusted according to a multiplying factor by moving the upper-body photographic apparatus 15 to regulate a camera position x.

Referring back to FIG. 2,the scattering transmission plate 18e for light scattering transmission is arranged around the upper-body photographic apparatus 15. Light irradiated from the upper fluorescent lamp 60b is subjected to scattering by the scattering transmission plate 18e, and that light irradiated from the upper fluorescent lamps 61a, 61a, which has experienced irregular reflection in the body apparatus 11, is further subjected to scattering by the scattering transmission plate 18e and is irradiated on a front surface of the user 50. The scattering transmission plates 18a, 18a are arranged on both sides of the display 20 and the scattering transmission plate 18e, and the scattering transmission plates 18b, 18d are arranged to connect to the scattering transmission plates 18a, 18a on the sides of the body apparatus 11. The scattering transmission plates 18c, 18c are arranged on both sides of the whole-body photographic apparatus 12 in the back-surface portion of the body apparatus 11. Light irradiated from the fluorescent lamp 60a, 60a on both sides of the scattering transmission plates 18c, 18c and from the strobe lamps 61b, 61b below the scattering transmission plates is subjected to scattering by these scattering transmission plates and is irradiated into the photographic space.

Arranged above the body apparatus 11 are the scattering transmission plate 18f and the reflector 65 as shown in FIG. 2. Light directed upward from the upper fluorescent lamp 60b and the upper strobe lamps 61a, 61a is subjected to scattering by the scattering transmission plate 18f and is reflected rearward by the reflector 65 to be irradiated into the photographic space.

The spot light 62 is arranged in a lower portion of the whole-body photographic apparatus 12 to function as auxiliary illumination apparatus for illuminating a part of a subject. The spot light 62 is arranged upwardly and obliquely so as to illuminate the chin of the user 50 in cases where the user 50 is located in a subject position suited to upper-body photography of the user 50. Since the insides of the shield curtains 33, 33 extending from the body apparatus 11 to the struts 31, 31 are colored with a low reflection coefficient to decrease a quantity of light irradiated on the sides of the user 50a, a shadow is produced on the user 50a. At this time, the shadow, which may not be desired by the user 50a (such as a shadow of the chin of the user 50a), is produced in the photographic image. To compensate for this, spot light 62 is provided to illuminate the chin of the user 50a, to help erase the undesired shadow(s).

The spot light 62 in FIG. 2 is arranged in a manner to illuminate the chin of the user 50 in the case where the user 50 is located in a subject position suited to upper-body photography of the user 50. Incidentally, the user 50a is liable to stay in a position irradiated by the spot light 62 so as to be able to perform photography adequately. Accordingly, it is possible to prevent the user 50a from approaching the photographic apparatus 15 too closely, thus enabling preventing overexposure.

In addition, it is preferable that the spot light 62 irradiate an amber-based (orange) light in order to preferably present a flesh color of a face of the user 50a. Also, in order to erase other shadows not desired by the user 50a, separate spot lights can be arranged in separate locations.

The coin slot 22 and the coin return port 23 are arranged in position (adjacent to the right of the whole-body photographic apparatus 12 in FIG. 2) on the back-surface portion of the body apparatus 11. The coin slot 22 is one, into which the user 50 deposits a predetermined number of coins as a charge of use for the photograph print system 10. The coin handling device 81 is provided inside the body apparatus 11 to be communicated to the coin slot 22.

The coin handling device 81 determines whether predetermined coins have been thrown in. In the case where it is determined that predetermined coins have been thrown in, the coin handling device informs the control device 27 of this and forwards the thrown-in coins to a coin container (not shown) for accumulating coins. Meanwhile, if it is determined that other coins than predetermined coins have been thrown in, the coin handling device forwards the thrown-in coins to the coin return port 23. In addition, in the case where a money changing machine for changing paper money and coins into predetermined coins is not present close to the photograph print system 10, a paper money slot may be additionally provided, along with a change handling device.

Turning to FIG. 4, the touch panels 24, 24 are provided centrally on the front-surface portion of the body apparatus 11. The touch panels 24, 24 comprise a touch sensor provided on a flat panel display or a display such as CRT or the like. The touch panels 24, 24 are preferably arranged in positions that are easily seen by a user and easy to be operated, and permit various messages, images, or the like in the image edition processing to be displayed thereon as well as various instructions, selections, or the like to be input thereinto by a user. Specifically, images may be displayed on the touch panels 24, 24, such as “doodles” or the like, which are to be edited at the time of image edition processing, and various edition tools.

Also, the touch pens 25, 25 are arranged in the vicinity (adjacent and below touch panels 24, 24 in FIG. 4) of the touch panels 24, 24 so a user may input operations for image edition processing. Under normal operation, a user brings the touch pens 25, 25 into contact with the touch panels 24, 24 to select buttons displayed in the course of various processing operation and draw images such as doodle or the like. Under t this embodiment, two sets of the touch panels 24, 24 and touch pens 25, 25 are provided in the photograph print system 10 in juxtaposition with each other as shown in FIG. 4. Thereby, two users can simultaneously input doodle or the like in photographed images, respectively, displayed on the two touch panels 24, 24.

In addition, different photographed images can be displayed on the touch panels 24, 24, so users can input doodles or the like in separate photographed images. Also, it is possible to perform reflecting processing, in which doodle inputs from one 24 of the touch panels is reflected on the other 24 of the touch panels, and a process for limiting a doodle region is possible.

Also, as shown in FIG. 3, a support frame 30 projects forward at its upper portion, and shield curtains 35, 36 are arranged respectively on both sides and a front side of the projected support frame 30. The space defined by the body apparatus 11 and the shield curtains 35, 36 are referred to as an edition space. Also, an illumination device 55 for illuminating the edition space is arranged in an upper portion of the front-surface of the body apparatus 11.

The print output device 28 serves to print an image output, and is arranged inside the body apparatus 11 as shown in FIG. 3. The print discharge port 26 permits a photograph print to be discharged from the print output device 28. The print discharge port 26 is arranged on one side or both sides of the body apparatus 11.

The control device 27 controls operations of various features in the body apparatus 11 as well as the background apparatus 40 in an integrated manner, and is arranged inside the body apparatus 11. Also, the speakers 21, 21c, 21d, are respectively arranged in positions on the back-surface portion, and the front-surface and sides of the body apparatus 11. The speakers 21, 21c, 21d output various voice guidance and sound effects.

The background apparatus 40 is disposed rearwardly from the body apparatus 11 and the user 50 to constitute a background in photography. For various backgrounds, a plurality of the background apparatuses 40 should preferably be provided.

The background apparatus 40 of FIG. 3includes a background body 42 and a background moving device 41 capable of moving the background body 42 to opposite ends. Preferably, the background body 42 should be shaped in the form of a curtain, sheet, or the like to be easily moved by the background moving device 41. Also, the background body 42 may be patterned and colored in various manners for actual backgrounds, and also may be mono-colored, such as blue or white, or non-patterned for composition of background images.

As shown in FIG. 3, a lifting device for winding up the background body 42 upward, and a curtain rail, guide rail, or the like permitting the background body 42 to be moved rightward and leftward can be used as the background moving device 41. In addition, the background body 42 can be moved manually, or automatically by a drive mechanism such as motor or the like.

A background light bending device 43 is arranged in front of the background body 42 for bending light toward the background body 42, or light from the background body 42. Here, bending of light is intended generally to mean change of direction of light, including refraction, reflection and diffraction of light. Since the background light bending device 43 is capable of variously changing light toward and from the background, more various backgrounds can be presented.

In addition, like the background apparatus 40, the background light bending device 43 may include a plurality of sheet-shaped light bending parts provided in the front and back. Furthermore, the light bending parts in the background light bending device 43 are made movable to opposite ends by mounting a lifting device for winding up sheet-shaped light bending parts to store therein the same, or mounting a curtain rail, on which curtain-shaped light bending parts hang. In this case, it is possible to use any one of the plurality of light bending parts, or some of the plurality of light bending parts in combination, so that more various backgrounds can be presented.

Also, the background light bending device 43 can be arranged either forwardly or rearwardly of the user 50, and can also be arranged to move longitudinally. For example, when light bending parts in the form of a strip of paper are arranged in front of the user 50 and a face of the user 50 projects from between the light bending parts, light from other portions of the user 50 is refracted to afford acquisition of more visionary photographed images.

In cases where the background body 42 is formed from a material through which light transmits, a background illumination device 63 for irradiating light on the background body 42 can be arranged rearwardly of the background apparatus 40 as shown in FIGS. 1 and 3. Accordingly, the background illumination device 63 can irradiate light uniformly on the background body 42 and can also irradiate light on a particular portion of the background body 42 to stress accents on a background. Also, the background illumination device 63 can irradiate light of different colors and can also irradiate light in the form of different configurations such circle, triangle, star, heart, or the like. Thereby, a background can be presented in various manners.

The background apparatus 40, background light bending device 43, and the background illumination device 63 are supported by the support frame 30, which supports the shield curtains 33 to 37, as described above.

Next, an explanation will be given to an upper illumination device 66 arranged above a user. The upper illumination device 66 comprises a strobe lamp 67 provided in a housing 68, and is disposed above the support frame 30. Internal surfaces of the housing 68, except a front surface 68a, are colored, for example, white with a high reflection coefficient. Also, the strobe lamp 67 is arranged with a direction of irradiation rearwardly upward so that reflection is repeated in the housing 68. An opening is formed in a front side of an underside of the housing 68. The opening defines a region offset from a photographic region of the camera 13 of the whole-body photographic apparatus 12. Thereby, light from the upper illumination device 66 can be prevented from being reflected at the time of whole-body photography.

A milk-white scattering transmission plate 69 is provided on the opening with its normal direction forwardly downward. Thereby, light irradiated from the strobe lamp 6 is reflected by the internal surfaces of the housing 68 to be subjected to scattering by the scattering transmission plate 69.

The front surface 68a of the housing is inclined downward, and an internal surface of the front surface 68a is colored, for example, black with a low reflection coefficient. Thereby, it is possible to prevent any excessive increase in quantity of light, which is reflected rearwardly downward from the front surface 68a to be irradiated on the user 50b who intends for whole-body photography.

With the above configuration, scattered light from the upper illumination device 66 is irradiated forwardly downward at the time a photograph is taken to illuminate from the rear a head of the user 50a. Thereby, a three-dimensional effect and texture of the user 50a can be represented in a photographed image.

FIG. 6 shows the configuration of the photograph print system 10 centering on the control device 27. The control device 27 controls operations of the various constitutions in the photograph print system 10 in an integrated manner. The control device 27 comprises, for example, a PC based computer. Control of operations of the various constitutions is performed by executing a control program on the computer. The program may be a configuration, in which a program recorded in a removable medium such as CD-ROM or the like is read out to be used, or a configuration, in which a program stored in a hard disk or the like is read out to be used. Also, in the case where the control device 27 is configured to be connected to a communication network such as Internet or the like, a configuration is conceivable, in which the program is downloaded via the communication network to be stored in a hard disk or the like to be executed.

The control device 27 in FIG. 6 comprises a storage unit 80 characterized by a non-volatile storage device such as a hard disk or the like. Contents stored in the storage unit 80 include the above-mentioned control program, OS (Operating System), other various programs, operation set values in the photographic apparatuses 12, 15, image data of photographed images and edited images, and so on. The operation set values in the photographic apparatuses 12, 15 include white-balance values set at the time of shipment and maintenance of a concerned apparatus, values of various parameters relating to the image processing at the time of adjustment of light and shade in photographed images, and so on.

When determining that predetermined coins have been thrown in from the coin slot 22 in the manner described above, the coin handling device 81 informs the control device 27 thereof. In response to the coin handling device, the control device 27 performs accounting functions, such as counting notices from the coin handling device 81 to control various operations for a user in accordance with an amount of money thrown by a user.

The print output device 28 of FIG. 6 comprises a printer 91 and an ID tag reader/writer 92. Sets of print sheets 93 are delivered to the print output device 28, which make output media for photograph prints, and ID tags (identification media) 94 as a print sheet unit 90. When image data is forwarded from the control device 27, the printer 91 performs printing operations on the print sheets 93 on the basis of the image data. Under the exemplary embodiment, sublimation-type printer may be utilized as printer 91. Ink film for a sublimation-type printer is delivered in a set in addition to the print sheets 93 and the ID tags 94.

The ID tag reader/writer 92 of FIG. 6 reads various identification information recorded on the ID tags 94 to output the same to the control device 27. The ID tags 94 comprise IC chips having a memory function under the exemplary embodiment. The identification information includes proper IDs, the number of sheets, kinds of sheets, color information peculiar to ink (the case where an ink film is made in a set), and so on.

The control device 27 determines, on the basis of identification information read by the ID tag reader/writer 92, whether the print sheets 93 and an ink film mounted are available in a specified photograph print system 10, and makes the printer 91 operable only in the case of availability. Settings are made such that other print sheets and ink film other than those specified in the photograph print system 10, cannot be used.

Also, the number of the remaining print sheets can be determined by counting down the number of sheets every use of print sheets on the basis of information recorded on the ID tags 94 with respect to the number of sheets. When the number of the remaining sheets becomes small, an alarm may be communicated via the display means to avoid sheets running out during the use by the user 50. Information recorded on the ID tags 94 with respect to the number of sheets is preferably rewritten when the number of sheets is counted down. Thereby, when sheets have run out, information recorded on the ID tags 94 with respect to the number of sheets becomes 0, so that it is possible to invalidate the ID tags 94. Also, images can be accurately output to print sheets 93, while ink film, color information (regarding types of inks) and correcting color component for image data may be updated by reading information recorded on the ID tags 94.

The ID tags 94 may also include non-contact type ID tags to allow data communication by way of wireless communication. ID tags provided with terminals, and the ID tag reader/writer 92 may corresponds to wireless or non-wireless systems, or both.

While the above example makes use of the ID tags 94 in order to confirm whether print sheets 93 are available, it is not limited as such, and may be configured to make use of bar codes printed on, for example, a package material, by which the print sheets 93 and an ink film are packaged.

The print sheets 93 are preferably paper sheets being an ordinary paper medium as well as seal sheets composed of adhesive sheets and peel-off sheets stuck to adhesive surfaces of the adhesive sheets.

With reference to FIG. 7, an explanation will be given to a play-operation including photography, edition and printing done by a user in the photograph print system 10 constructed in accordance with the embodiments described above When a user enters the photograph print system 10 (STEP S1, which is alterantely referred below to as “S1”) and throws coins as a charge from the coin slot 22, the coin handling device 81 (FIG. 6) informs the control device 27 of throwing-in of coins and the accounting processing is executed (S2). When it is confirmed that the accounting processing has been completed normally, the play-operation is started and the following processing is executed.

First, the photographic processing is executed (S3). The photographic processing is executed in the following manner under the exemplary embodiment. First, setting of the number of photographs and time of photography is done. That is, the background body 42 having a pattern desired by the user 50 is developed by the background moving device 41. These operations can be manually done by the user 50, and can also be automatically done by control of the print discharge port 26 effected by the control device 27 on the basis of an operation of the remote manipulators 32 performed by the user 50.

Next, setting of photography is done. That is, selection of the whole-body photographic apparatus 12 or the upper-body photographic apparatus 15 and adjustment of photographic angle are effected. In the case where the upper-body photographic apparatus 15 is selected, the upper-body photographic apparatus 15 is manually or automatically moved to a suitable position rearwardly of the body apparatus 11.

Next, in the case of whole-body photography, a live view image photographed by the camera 13 of the whole-body photographic apparatus 12 is displayed on the LCD 14. In the case of upper-body photography, a live view image photographed by the camera 16 of the upper-body photographic apparatus 15 is displayed on the LCD 14. The user 50 strikes a desired pose referring to the live view image, and depresses a photography button of the remote manipulators 32 at a desired timing, to execute a photograph after a predetermined countdown. In cases where additional photography is required, the processing returns to STEP S3 for repetition of the above photographic processing, and in cases where photography is to be terminated, the processing proceeds to the next editing processing (S4).

Still referring to FIG. 7, the image editing processing is executed for photographed images having been acquired in the photographic processing (S5). The editing processing is mainly executed in the following manner under a preferred embodiment. First, a plurality of acquired photographic images from previous instances are displayed on the touch panel 24, and photographed images for the editing processing (such as doodle or the like) are selected from the plurality of photograps. Thereby, an image suited to a user's taste can be selected by removing undesired photograpic images.

Subsequently, the selected image is displayed on the touch panel 24, and the editing of images such as modification of color, doodle, or the like is made on the photographed image with the use of the touch pen 25. In addition, in the case where the background body 42 is a curtain with no pattern, that is, a mono-colored and non-patterned curtain, a background image is selected and combined with the photographed image in the image editing processing. At this time, since a shade of the user 50 is not reflected in a background of the photographed image in the embodiment, the background of the photographed image is uniform in brightness. Accordingly, a subject in the photographed image and the background image can be combined with each other more accurately as compared with prior art systems.

In cases where editing is performed on images, the editing processing (S5) is repeated, and in cases where editing of images is terminated, the processing proceeds to STEP S6. Subsequently, the process for outputting photograph prints is executed (S7). The outputting process is mainly executed in the following manner under a preferred embodiment. First, the user is permitted to select the number of division or a pattern of division on a print sheet 93, and printing is performed by controlling the printer 91 so that edited images having been subjected to editing processing in STEP S5 are printed every divided region as selected. Thereafter, photograph prints having been printed are discharged from the print discharge port 26, and so the operation of the user is terminated.

It should be noted that the invention is not limited to the embodiments described above, and may be subject to various modifications within the scope of the claims shown below.

As an example, while a single spot light 62 is arranged in the lower portion of the back-surface of the body apparatus 11 in the embodiment, spot lights, respectively, may be arranged on both sides of the back-surface of the body apparatus 11, such as in the lower corners of the scattering transmission plates 18a, 18a to illuminate the upper half of the body of the user 50a. Thereby, even when a plurality of users 50a want to perform upper-body photography, a shadow generated at the time a photograph is taken can be decreased by light from the plurality of spot lights and so preferable photographed images can be acquired.

Furthermore, spot lights, can be arranged in the upper corners of the scattering transmission plates 18a, 18a to illuminate the user 50a from above. As an example, when light from the spot lights is of an amber-based color, it is possible to preferably present a flesh color of a face of the user. Also, when spot lights are arranged in the lower and upper corners of the scattering transmission plates 18a, 18a, there can be provided an effect as if the user 50a appears on the stage to be photographed, so that the user 50a can expect to perform photography more enjoyably in a photographic space.

While the manipulator 32 operated by the user 50 is mounted in the vicinity of a photographed position of the user 50 in the embodiment, it is not limited to such arrangement but can be mounted in optional positions to afford the user 50 easy handling or can be mounted in a plurality of locations. For example, the manipulator can be mounted in the vicinity of the display 20. With general photograph print systems, a manipulator is in many cases mounted in the vicinity of a display unit, so that the above configuration makes it possible for a user, who is familiar to such systems, to perform operations with little difficulty. Since the upper-body photographic apparatus 15 can be taken out rearward, however, there is the possibility that a user may accidentally strike him/herself against the upper-body photographic apparatus 15 during operation. To minimize such instances, it is preferable that a sensor be disposed within the system for detecting when the upper-body photographic apparatus 15 has been taken out. Additionally, the speakers 21, 21 may output a voice alarm message such as “please be careful—the upper camera has been taken out” to call a user's attention.

Also, in cases where the manipulators are installed in a plurality of locations, such as right and left of the body apparatus 11 in the vicinity of the display 20, or the like, a user can perform operations in a position that may be easier to use. In this case, the input exclusion control apparatus can be provided to accept only an operation from an initially input manipulator, which is determined by input data received from the manipulators. Thereby, it is possible to accept input with minimal confusion.

Also, the reflective curtains 19, 19 can be configured to be extended from and rolled around sides of the body apparatus 11. In this case, when a surplus space is configured laterally from the photograph print system, the photographic space is enlarged further and the light emitting surface can be realized by further extending the reflective curtains 19, 19. Since the reflective curtains 19, 19 can be made different in width between right and left to thereby be made different in area, the photographic space can be made different in brightness between right and left, so that it is possible to realize photographs in a different manner. Also, the reflective curtains 19, 19 can be configured to be foldable on sides of the body apparatus 11 as if the wings are folded.

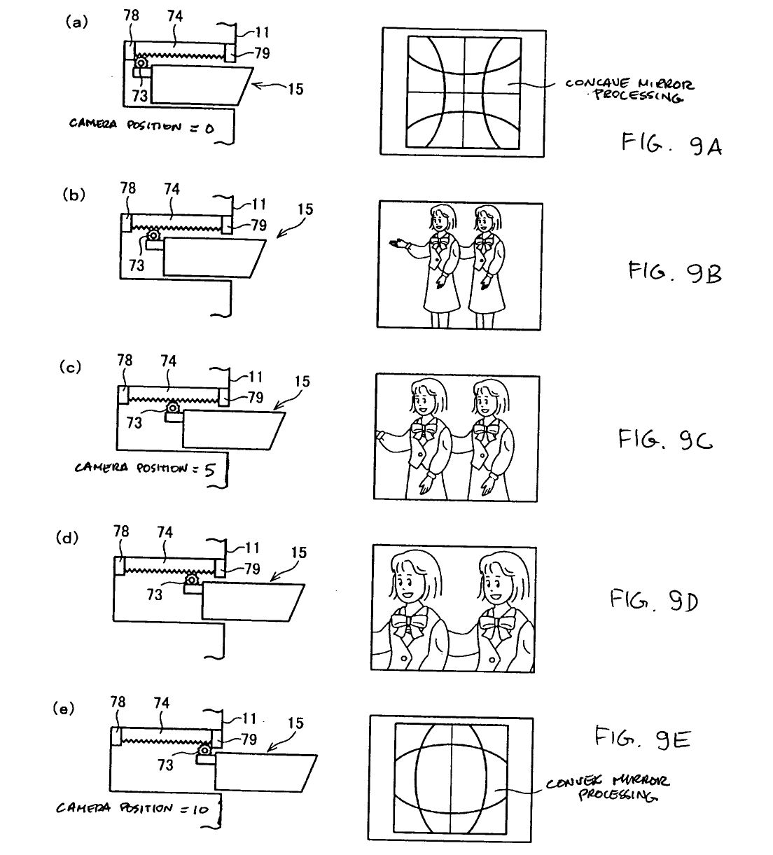

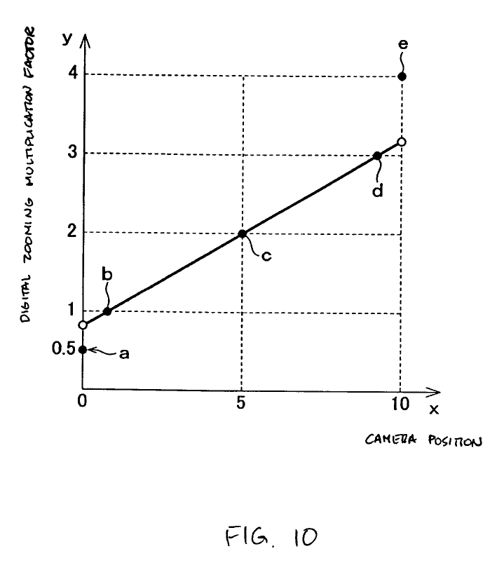

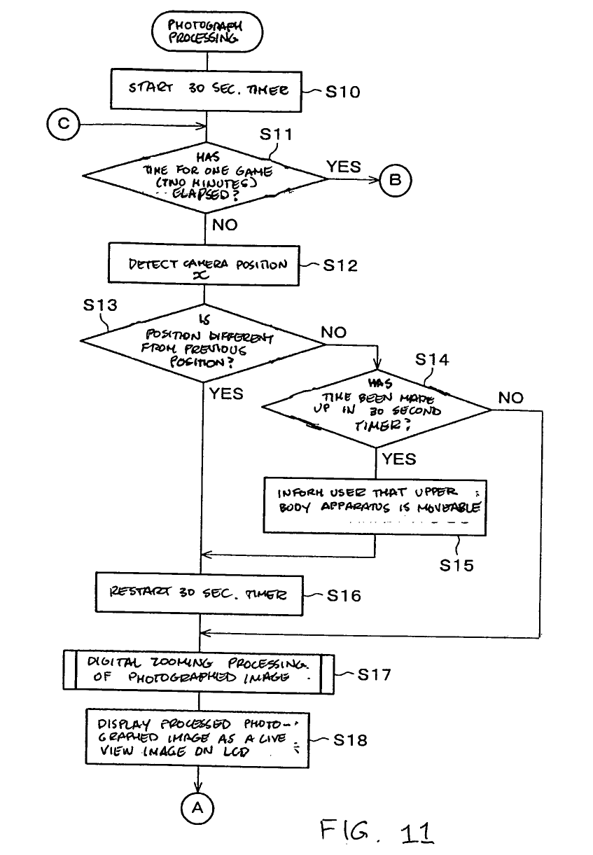

An explanation will be given as follows to another embodiment of the invention with reference to FIGS. 9 to 15. A photograph print system according to this embodiment is different from the photograph print system according to the previous embodiments in that a rotary encoder (travel detection means) is provided on the pinion 73 (see FIG. 5). The rotary encoder is preferably mounted in the upper-body photographic apparatus 15, wherein a digital zooming processing for scaling of photographed images is performed on the basis of a camera position x calculated by the rotary encoder. An image having been subjected to digital zooming is displayed as a live view image on the LCD 17. In addition, configurations having the same functions as those of the configurations described in the embodiments above are denoted by the same reference numerals, and an explanation thereof is omitted for the purposes of simplicity.

Under an exemplary embodiment, the upper-body photographic apparatus 15 is restricted in the distance by which it can project out from the body apparatus 11. In some cases, the user 50 cannot perform photography at a particular multiplying factor, which is desired by the user 50. For example, referring to live view images shown in FIGS. 8A to 8E, a range of photography in the photograph print system extends above the waist of the user 50 under a high multiplying factor, and extends above the knees of the user 50 under a low multiplying factor. In this case, it may not be possible to comply with a demand of the user 50 for bust-shot photography and full-shot photography.

To compensate for this, a camera position x of the upper-body photographic apparatus 15 is calculated by the rotary encoder provided on the pinion 73. The digital zooming processing for scaling photographed images is then performed on the basis of the calculated camera position x, and an image having been subjected to digital zooming processing is displayed as a live view image on the LCD 17.

FIGS. 9A to 9E shows how a live view image displayed on the LCD 17 is varied depending upon a camera position x. It is noted that states shown in FIGS. 9A to 9E correspond to states shown in FIGS. 8A to 8E in connection with the photograph print system shown in the previous embodiment. A camera 16 of an upper-body photographic apparatus 15 preferably uses a lens group having an optical multiplying factor of ½ of that in the camera 16 of the upper-body photographic apparatus 15 shown in the previous embodiment.

FIG. 10 illustrates changes in the multiplying factor due to the digital zooming processing (referred below to as “digital zooming multiplying factor”) relative to a camera position x. Characters “a” to “e” shown in the graph correspond to states shown in FIGS. 9A to 9E. As shown in FIG. 10, a digital zooming multiplying factor is initially set to 1 (equal magnification). The state in FIG. 9B increases in proportion to the camera position x, wherein the state doubles as shown in FIG. 9C, and becomes triple as shown in FIG. 9D.

Here, a comparison is made between live view images in the embodiment shown in FIGS. 9A to 9E and live view images in the first embodiment shown in FIGS. 8A to 8E. When a camera position x is 5, the live view image, shown in FIG. 9C, has substantially the same range of photography as that of a live view image shown in FIG. 8C. When a camera position x is smaller than 5, the live view image, shown in FIG. 9B, has a photographic range that is larger than the live view image shown in FIG. 8B. Also, when the camera position x is larger than 5, the live view image shown in FIG. 9D has a smaller photographic range than the live view image shown in FIG. 8D. In this manner, it is possible according to the present embodiment to perform full-shot photography as shown in FIG. 9B and bust-shot photography as shown in FIG. 9D.

Accordingly, when the upper-body photographic apparatus 15 is restricted in a distance by which it can project from the body apparatus 11, the range of photography can be further enlarged or narrowed by performing the digital zooming processing, so that it is possible comply with various demands of the user for various ranges of photography. Also, when the range of photography is narrowed by decreasing a distance between the camera 16 and the user 50, there may be cases where the user 50 feels a sense of incongruity with a photographed image. This may happen when an optical distortion occurs when a part of the user, such as the nose or the like, is too close to the camera 16 under an enlarged scale. To compensate for this, digital zooming processing is used to enlarge a photographed image and cut down its central portion, wherein respective parts of the user, such as eyes, nose, cheeks, or the like are enlarged in equal magnification. Additionally, the digital zooming processing for scaling photographed images may be performed so that a digital zooming multiplying factor is made 1 (as shown in FIG. 9C), and is made less than 1 in cases where the camera position x decreases from the state shown in FIG. 9C, and is made larger than 1 in the case where the camera position x increases from the state shown in FIG. 9C.

An additional processing method, referred to as “concave-mirror processing”, may further reduce a central portion of a photographed image and enlarge a surrounding portion thereof. The concave mirror processing is preferably performed in the digital zooming processing, and is shown in FIG. 9A. When the camera position x is zero, the upper-body photographic apparatus 15 is set at an initial state in the body apparatus 11, and has the maximum distance set from a user 50. When the user 50 is photographed in a central portion, it is possible to acquire an purposefully distorted image, in which the user's 50 photographic image is reduced with the background being distorted.

Also, a process method, referred to as “convex-mirror processing, enlarges a central portion of a photographed image and reduces a surrounding portion thereof The convex mirror processing is also preferably performed as part of the digital zooming processing, and is shown in FIG. 9E. When the camera is extended to a maximum position (x=10), the upper-body photograpic apparatus 15 projects to a maximum from the body apparatus 11. Accordingly, a purposefully distorted image will result, in which the user 50 is further enlarged and a background is distorted.

The camera position (0<x<10) can be detected by performing a calculation process in the rotary encoder provided on the pinion 73, as described above. Alternatively, contact sensors 78, 79 may be provided in limit positions, to which the upper-body photograpic apparatus 15 can be moved, as shown in FIGS. 9A to 9E and the fact that a camera position x has reached 0 or 10 may be detected on the basis of signals from the contact sensors 78, 79.

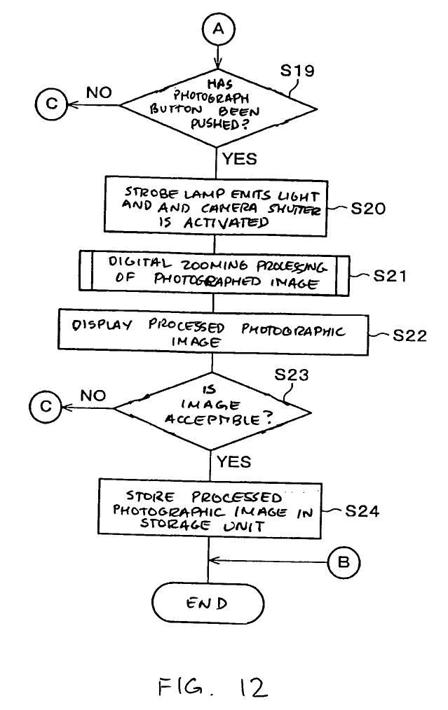

Next, an explanation will be given to processing operations of the photograph print system according to yet another exemplary embodiment. The processing operations of the photograph print system described below modifies the processing (S3) from the processing operations of the photograph print system shown in FIG. 7. Accordingly, the photographic processing will be described below in detail with reference to FIGS. 11 to 13, and an explanation for the remaining processes will be omitted for the purposes of simlicity.

Referring to FIG. 11, a 30-second timer is provided in a control device 27 and is initially started in step S10. Subsequently, it is determined whether time for one session (two minutes under an exemplary embodiment) has elapsed (S11). Once the time elapses, the photographic processing is terminated. Otherwise, a camera position x is detected on the basis of a signal from the rotary encoder (S12). Next, a determination is made as to whether the detected camera position x is different from a previously detected camera position x (S13). If the camera positions are the same, it is then determined whether the camera position x has been moved over the predetermined (30-second) time period (S14).

If the photographic apparatus 15 has not been moved over the predetermined time period (30 seconds), a display 20 or a speaker 21 outputs a message (e.g., “The camera can be moved. If you like, you may move the camera.”) whereby the user 50 is informed that the upper-body photographic apparatus 15 is movable (S15). In response to the message, the user 50 can adjust the position of the upper-body photographic apparatus 15.

Since the processing in STEP S13 determines whether the upper-body photography apparatus 15 has been moved, a processing step for detecting a signal from a vibration sensor provided on the upper-body photography apparatus 15 may additionally be executed instead of STEP S12. Likewise, in the case where the upper-body photographic apparatus 15 is automatically moved by an operation from the remote manipulators 32, a processing step for detecting an operation signal from the remote manipulators 32 may be executed instead of STEP S12. In this manner, the processing steps in STEP S12 to STEP S15 may use means for directly or indirectly detecting movements of the upper-body photographic apparatus 15. as Alternately, a rotary encoder, may detect a travel of the upper-body photographic apparatus 15 as well.

After STEP S15, the 30-second timer is reset to 0 (S16). Also, since the upper-body photographic apparatus 15 has been moved in the case where a camera position x is different from a camera position x as detected at the last time in STEP S13, the 30-second timer is restarted from 0 without executing STEP S14 and STEP S15 (S16).

After STEP S16, the digital zooming processing of the photographed image is executed (S17). In cases where time has not yet reached the predetermined time period (30-seconds) in STEP S14, the digital zooming processing of a photographed image is executed without executing STEP S15 and STEP S16 (S17).

FIG. 13 illustrates exemplary operations in the digital zooming processing of a photographed image. First, a camera position x is determined (S30). In cases where a camera position x is larger than 0 and smaller than 10, the digital zooming processing is executed so that a multiplying factor y becomes (⅕)×x+1 (S33). Thereafter, the processing returns to an original state. In cases where a camera position x is 0, the display 20 or the speaker 21 outputs a narration “concave-mirror processing” in step S31. Subsequently, the digital zooming processing is performed on the photographed image so that the multiplying factor y becomes 0.5, and concave-mirror processing is further performed (S32). Thereafter, the processing returns to an original state.

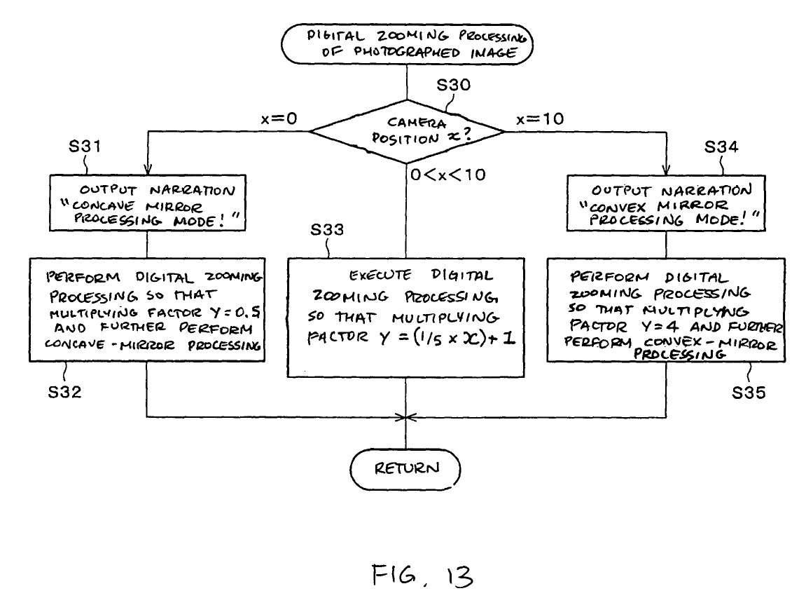

casein cases where the camera position x is 10, the display 20 or the speaker 21 outputs a narration “convex-mirror processing” in step S34. Subsequently, the digital zooming processing is performed on a photographed image so that the multiplying factor y becomes 4, and the convex-mirror processing is further performed (S35). Thereafter, the processing returns to an original state. After the digital zooming processing of a photographed image is performed in step S17, the processed photographed image is displayed as a live view image on the LCD 17 (S18). Subsequently, a determination is made whether a photograph button has been pushed, as shown in FIG. 12 (S19). When the photograph button has not yet been pushed, the processing returns to STEP S11 and the above processing steps are repeated.

When the photograph button has been pushed, the strobe lamp emits light and a shutter of the camera is actuated to take a photograph (S20). Subsequently, the same digital zooming processing as that described above is performed on a photographed image acquired in the photograph (S21), and the processed photographed image is displayed on the display 20 this time (S22).

Subsequently, the user 50 determined whether the image displayed on the display 20 is acceptable (S23). In the case where the user is dissatisfied with the image displayed on the display 20, the photographed image is discarded, and the processing returns to STEP S11 where the above processing steps are repeated. If the user is satisfied with the image displayed on the display 20, the processed photographed image is stored in the storage unit 80 (S24). Thereafter, the photographic processing is terminated.

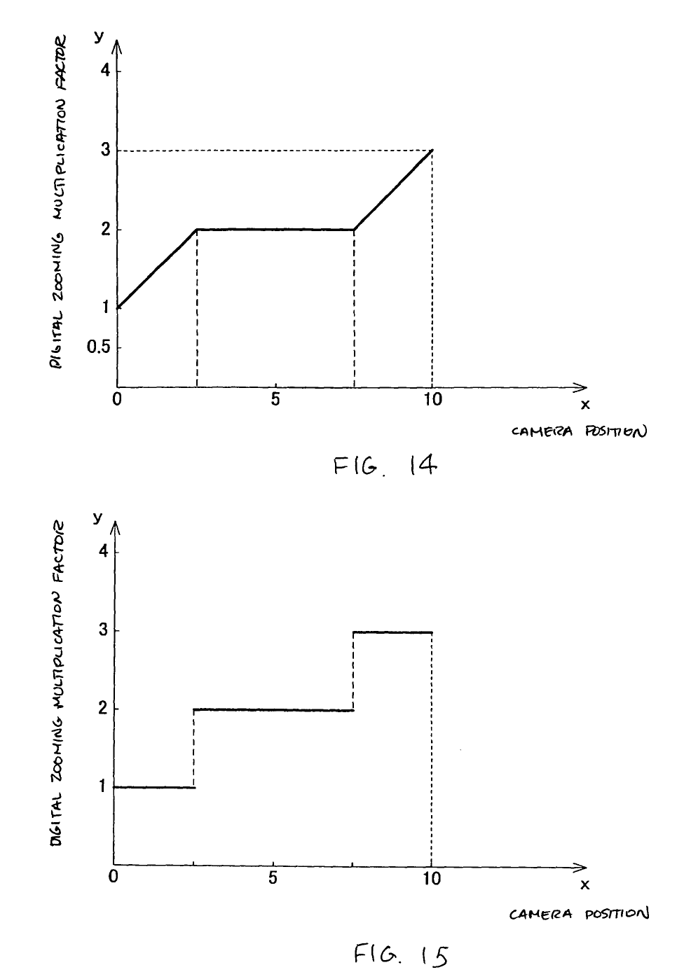

In addition, in the case where the upper-body photographic apparatus 15 possesses an optical zooming function, digital zooming and optical zooming can be used in combination. FIG. 14 shows changes in digital zooming multiplying factor, relative to a camera position x in the case where digital zooming and optical zooming can be used in combination. Under the exemplary embodiment is assumed that optical zooming serves as a linear enlargement relative to a camera position x. In cases where a camera position x is located close to a center portion (2.5≦x≦7.5), only optical zooming serves for scaling with the digital zooming multiplying factor fixed at 2×. Thereby, it is possible to suppress changes in the zooming multiplying factor of an image displayed on the LCD 17 to perform fine adjustment in range of photography. Under a preferred embodiment, most users can perform adjustment in this region (2.5≦x≦7.5).

In cases where a camera position x is located toward the body apparatus 11 (0≦x<2.5), or toward a user (7.5<x≦10), the processing steps for scaling is performed linearly on a camera position x by means of digital zooming in addition to scaling by optical zooming.

When a camera position x is moved toward the body apparatus from the center portion, the processing steps for reduction is performed by means of digital zooming in addition to reduction by optical zooming. Thereby, the range of photography can be further enlarged as compared to optical zooming only. Also, when a camera position x is moved toward a user from the center portion, the processing for enlargement is performed by means of digital zooming in addition to enlargement by optical zooming. Thereby, the range of photography can be further reduced as compared with optical zooming only.

In cases where a camera position x is moved toward the body apparatus from the center portion as shown in FIG. 15, reduction may be performed only by means of optical zooming with the digital zooming multiplying factor fixed at 1×, and the concave-mirror processing may be further performed in such a manner that distortion increases as a camera position x becomes small. In such a case, as a camera position x is moved toward the body apparatus from the neighborhood of the center, distortion due to the concave-mirror processing increases in addition to reduction by optical zooming, so that a desired distortion can be obtained by the user 50.

Likewise, in cases where a camera position x is located toward a user from the center portion as shown in FIG. 15, enlargement may be performed only by means of optical zooming with the digital zooming multiplying factor fixed at 3×, and the convex-mirror processing may be further performed in such a manner that distortion increases as a camera position x becomes large. In such a case, as a camera position x moves toward a user from the center portion, distortion due to the convex-mirror processing increases in addition to enlargement by optical zooming, so that a desired distortion can be obtained by the user 50.

Effects similar to those described above can be produced even when the upper-body photographic apparatus 15 is stationary and the digital zooming multiplying factor is varied in a manner shown in FIGS. 14 and 15 on the basis of an optical zooming multiplying factor in place of a camera position x. Also, in cases where the upper-body photographic apparatus 15 is moved by the motor 71 without resorting to user 50 intervention, and a rotary encoder is housed in the motor 71, the rotary encoder housed in the motor 71, and the provision of a rotary encoder on the pinion 73 should be sufficient to serve as the travel detection means/apparatus.

The invention is not limited to the respective embodiments described above, but is subject to various modifications within the scope described in the claims, and embodiments obtained by appropriately combining technical means disclosed in different embodiments.

As described above, the photograph print system according to the invention comprises illumination apparatus for illuminating a subject, where the illumination apparatus sets a direction of illumination to be offset from a direction toward the subject. Thereby, when the subject approaches the photographing apparatus to thereby reduce a distance between the subject and the illumination apparatus. The quantity of light irradiated directly on the subject from the illumination apparatus will generally be smaller than that in the prior art, so that increases in the quantity of light irradiated on the subject will be suppressed.

Further, a reflection apparatus provided laterally from a photographing space in which photography is performed, helps to reflect light from the illumination apparatus. Thereby, even when the quantity of light irradiated directly on the subject from the illumination apparatus decreases, a quantity of light reflected by the reflection apparatus and irradiated indirectly on the subject from the illumination apparatus increases Accordingly, the intensity of illumination on a subject can be decreased, when the direction of illumination of the illumination apparatus is offset from a direction toward the subject.

Also, light from the illumination apparatus is reflected by the reflection apparatus provided laterally from the photographing space to thereby detour the subject to be able to reach a background curtain behind the subject. Accordingly, a shadow of the subject can be suppressed from being reflected in the background curtain, with the background region of the photographed image becoming more even in brightness As a result, the photographed image and a background image can be combined with accuracy.

The reflection apparatus preferably has a small light reflection coefficient, measured from a position close to the illumination apparatus to a position close to a preferable subject position in cases where the photographing apparatus performs near-by photographing. Since light irradiated on the sides of the subject is made smaller in quantity than light irradiated on a front surface of the subject, a shadow is generated on the subject having a three-dimensional photographic effect.

Further, the auxiliary illumination apparatus operates to remove unnecessary shade generated on the subject by illumination of the illumination apparatus in cases where the near-by photographing is performed. Thereby, the auxiliary illumination apparatus illuminates a part of a subject whereby an undesired shadow can be removed from a photographed image. Also, when the auxiliary illumination apparatus is arranged to illuminate a subject present in a photographic space, it is possible, in cases of near-by photographing, to prevent a user from approaching the photographing apparatus too closely, and thereby preventing overexposure as a result.

Also, as described above, the invention adds to the photograph print system, which comprises photographing apparatus for photographing a user, and image output apparatus for forming an image on the basis of the photographing to output the same to a print sheet. Additionally, an operation apparatus, which is provided in the vicinity of a subject position is provided with which a user operates to manipulate the photographing apparatus. Thereby, when operating the photographing apparatus, a user should stay in a position, in which the operation apparatus for operating the photographing apparatus is present, so that it is possible to prevent a user from approaching the photographing apparatus too closely, thereby preventing overexposure. Also, as described above, the invention adds to the photograph print system, which comprises photographing apparatus for photographing a subject and image output apparatus for forming an image on the basis of the photographing to output the same to a print sheet, a feature that the photographing apparatus is arranged to be able to move toward the subject. Thereby, when the photographing apparatus is moved toward the subject in cases where it is desired that the subject approach the photographing apparatus, the subject will not approach the illumination apparatus too much. And even when the subject approaches the photographing apparatus too closely, an effect is produced wherein the intensity of illumination on a subject is not excessive.

Further, as described above, a photograph print system is disclosed, wherein a movement detection apparatus for detecting movements of the photographing apparatus is provided. By utilizing voice output of speakers and image output on a display, the user may be informed that the photographing apparatus is movable, or alternately be urged to move the photographing apparatus, in cases where the movement detection apparatus does not detect movements of the photographing apparatus.

Also, as described above, the movement detection apparatus comprises a travel detection apparatus for detecting a travel of the photographing apparatus. Accordingly, it is possible to inform a user of various notices such as a travel and the remaining possible travel, and it is possible to adjust various settings, such as an optimum quantity of light of an illumination device for photographing, or the like, to an optimum.

Further, as described above, a digital zooming apparatus is provided for performing a digital zoom processing for enlargement and/or reduction of the photographed image on the basis of the travel detected by the travel detection apparatus. The photographed image display apparatus displays, as a photographed image, an image having been subjected to digital zooming processing by the digital zooming apparatus. Accordingly, the digital zoom processing can compensate for enlarged photographing or reduced photographing of a subject so that it is possible to perform sufficient enlarged photographing or reduced photographing of a subject. Also, an image having been subjected to the digital zoom processing is displayed on the photographed image display apparatus whereby a user can perform photographing at an appropriate magnification while seeing an image displayed on the photographed image display apparatus.

Further, as described above, the photographing apparatus is provided with an optical zooming function, a photographed image display apparatus for displaying a photographed image, and a digital zooming apparatus for performing digital zoom processing for enlargement and/or reduction of the photographed image on the basis of a multiplying factor provided by the optical zooming function of the photographing apparatus. The photographed image display apparatus displays, as a photographed image, an image having been subjected to the digital zooming processing by the digital zooming apparatus. Accordingly, the digital zooming processing can compensate for enlarged photographing or reduced photographing of a subject, so that it is possible to perform sufficient enlarged photographing or reduced photographing of a subject. Also, an image having been subjected to the digital zooming processing is displayed on the photographed image display apparatus whereby a user can perform photographing at an appropriate magnification while seeing an image displayed on the photographed image display apparatus. Further, as described above, t the digital zooming apparatus further performs, on the photographed image, a processing of enlarging a central portion thereof and reducing a surrounding portion thereof, or a processing of reducing a central portion thereof and enlarging a surrounding portion thereof. Thereby, when a subject is photographed to be disposed in a central portion of a photographed image, it is possible to acquire purposefully distorted image, in which the subject is appropriately enlarged or reduced.

Also, as described above, a method of controlling a photograph print system is disclosed. In cases where the movement detection apparatus does not detect movements of the photographing apparatus for a predetermined period of time, the information providing apparatus notices the user that the photographing apparatus can be moved. Thereby, the user may be informed that the photographing apparatus can be moved, or to urge the user to move the photographing apparatus.

Also, as described above, the invention provides the method of controlling a photograph print system, comprising the steps of performing digital zoom processing for enlargement and/or reduction of the photographed image on the basis of the travel detected by the travel detection apparatus, and displaying, as a photographed image, an image having been subjected to digital zoom processing, on the photographed image display apparatus. Thereby, the digital zoom processing can compensate for enlarged photographing or reduced photographing of a subject, so that it is possible to perform sufficient enlarged photographing or reduced photographing of a subject. Also, there is produced an effect that an image having been subjected to the digital zooming processing is displayed on the photographed image display apparatus whereby a user can perform photographing at an appropriate magnification while seeing an image displayed on the photographed image display apparatus.

Further, as described above, the digital zoom processing comprises performing, on the photographed image, a process for enlarging a central portion thereof and reducing a surrounding portion thereof in cases where the photographing apparatus is moved to a neighborhood of a position closest to the subject. The process reduces a central portion of the photographed image and enlarges a surrounding portion thereof in cases where the photographing apparatus is moved to a neighborhood of a position most distant from the subject, and a process for enlarging or reducing the photographed image at an equal magnification in other cases. Under this process, an image being different in multiplying factor between a central portion thereof and a surrounding portion thereof can be acquired and a purposefully distorted image can be acquired in cases where the photographing apparatus is moved to a neighborhood of limits of movements of the photographing apparatus. Also, an image being of the same in multiplying factor between a central portion thereof and a surrounding portion thereof can be acquired and a correct enlarged or reduced image can be acquired in the case where the photographing apparatus is moved to other positions. Accordingly, there is produced an effect that both a correct photographed image and a purposefully distorted photographed image can be presented to a user.

Also, as described above, a method of controlling a photograph print system is disclosed, wherein the method comprises the steps of performing a digital zoom processing for enlargement and/or reduction of the photographed image on the basis of a multiplying factor provided by the optical zooming function of the photographing apparatus, and displaying, as a photographed image, an image having been subjected to the digital zooming processing, on the photographed image display apparatus.

Thereby, the digital zooming processing can compensate for that enlarged photographing or reduced photographing of a subject, so that it is possible to perform sufficient enlarged photographing or reduced photographing of a subject. Also, there is produced an effect that an image having been subjected to the digital zooming processing is displayed on the photographed image display apparatus whereby a user can perform photographing at an appropriate magnification while seeing an image displayed on the photographed image display apparatus.

Further, as described above, a method of controlling a photograph print system is disclosed, wherein the digital zoom processing comprises performing, on the photographed image, a process of enlarging a central portion thereof and reducing a surrounding portion thereof in cases where the multiplying factor provided by the optical zooming function of the photographing apparatus becomes substantially maximum. The process further reduces a central portion thereof and enlarges a surrounding portion thereof in cases where the multiplying factor becomes substantially minimum, and a processing for enlarging or reducing the photographed image at an equal magnification is produced in other cases. Thereby, an image having different multiplying factors between a central portion thereof and a surrounding portion thereof can be acquired and a purposefully distorted image can be acquired in cases where the multiplying factor provided by the optical zooming function of the photographing apparatus is moved to a variety of limits. Also, an image having substantially the same multiplying factor between a central portion thereof and a surrounding portion thereof can be acquired and a correct enlarged or reduced image can be acquired in cases where the photographing apparatus is moved to other positions. Accordingly, both a correct photographed image and a purposefully distorted photographic image can be presented to a user.

In addition, the method of controlling a photograph print system can be executed as a control program of a photograph print system by a computer. Further, the control program of a photograph print system is recorded in a computer-readable recording medium, whereby the method of controlling a photograph print system can be executed on an optional computer.

Also, as described above, a print sheet unit, used in the photograph print system, is also disclosed, wherein the print sheet unit comprises print sheets permitting an image to be printed thereon, and an identification medium, on which identification information with respect to the print sheets is recorded. Identification information recorded on the identification medium is read by an identification information reading apparatus, which is provided in the photograph print system, and an image is output to the print sheets after the contents of the identification information is confirmed. Thereby, a setting can be made so that other print sheets than those specified in a photograph print system cannot be used. Also, by containing information of the number of sheets in the identification information, the number of the remaining sheets can be determined by counting down the number of sheets every use of sheets. Also, by containing information regarding the kinds of sheets that are present within the identification information as well, images can be correctly output to sheets and ink film by correcting color components of an image data in view of the identification information.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. It is understood that the system and logic structures described in the embodiments above can substituted with equivalent system and logic structures to perform the disclosed methods and processes. Accordingly, the invention is not limited by the foregoing description or drawings, but is only limited by the scope of the appended claims.

What is claimed as new and desired to be protected by Letters Patent of the United States is:

1. A photographic print system, comprising:
a photographic apparatus for capturing a photographic image, in a linear direction, of a subject present within a photographic space;
an image output apparatus for outputting said photographic image to a print sheet; and
an illumination apparatus, wherein said illumination apparatus provides a direction of illuminating light within the photographic space that is offset from the linear direction.

2. The photographic print system according to claim 1, further comprising a reflection apparatus that is positioned laterally from the linear direction, wherein said reflection apparatus reflects the illuminating light provided from the illumination apparatus.

3. The photographic print system according to claim 2, wherein the reflection apparatus is comprised of a material having a small light reflection coefficient.

4. The photographic print system according to claim 1, further comprising a secondary illumination apparatus that is positioned to offset shading produced by the illumination apparatus on the subject.

5. A photographic print system, comprising:
photographic apparatus for capturing a photographic image, in a linear direction, of a subject present within a photographic space;
image output apparatus for outputting said photographic image to a print sheet; and
operation apparatus for activating said photographic apparatus, said operation apparatus being positioned within the photographic space.

6. A photographic print system, comprising:
photographic apparatus for capturing a photographic image of a subject present within a photographic space;
image output apparatus for outputting said photographic image to a print sheet; and
moving apparatus for physically moving said photographic apparatus in a direction towards the subject.

7. The photographic print system according to claim 6, further comprising a movement detection apparatus for detecting the physical movement of the photographic apparatus.

8. The photographic print system according to claim 7, wherein the movement detection apparatus includes a travel detection apparatus for detecting travel of the photographic apparatus.

9. The photographic print system according to claim 8, further comprising:
an image display apparatus for displaying the photographed image captured from the photographic apparatus; and
a digital zooming apparatus, wherein said zooming apparatus performs digital zoom processing on the captured photographic image on the basis of travel detected by the travel detection apparatus.

10. The photographic print system according to claim 9, wherein said image display apparatus displays the image subjected to digital zoom processing.

11. The photographic print system according to claim 9, wherein the digital zooming apparatus enlarges a central portion of the captured image and reduces a surrounding portion thereof.

12. The photographic print system according to claim 9, wherein the digital zooming apparatus reduces a central portion of the captured image and enlarges a surrounding portion thereof.

13. A photographic print system, comprising:
photographic means for capturing a photographic image of a subject present within a photographic space, said photographic apparatus further transmitting optical zooming data that includes a multiplying factor;
image output means for outputting said photographic image to a print sheet;
a digital zooming apparatus for digitally enlarging and/or reducing captured images based on the multiplying factor; and
image display means for displaying digitally enlarging and/or reducing captured images.

14. The photographic print system according to claim 13, wherein the digital zooming apparatus enlarges a central portion of the captured image and reduces a surrounding portion thereof.

15. The photographic print system according to claim 13, wherein the digital zooming apparatus reduces a central portion of the captured image and enlarges a surrounding portion thereof.

16. A method of controlling a photographic print system, comprising the steps of:
moving a photographic apparatus towards or away from a subject;
detecting movement and placement of the photographic apparatus during a predetermined period of time; and
transmitting a communication to the subject if it is determined that the photographic apparatus has not been moved at the expiration of the predetermined period of time.

17. A method of controlling a photographic print system, comprising the steps of:
moving a photographic apparatus towards or away from a subject;
detecting the travel of the photographic apparatus;
acquiring an image from said photographic apparatus; and
performing digital zoom processing on said image, wherein said digital zoom processing is performed on the basis of the detected travel.

18. The method according to claim 17, further comprising the step of displaying the digitally processed image.

19. The method according to claim 17, wherein the digital zooming processing enlarges a central portion of the captured image and reduces a surrounding portion thereof when the travel is detected to be in a position closest from the subject.

20. The method according to claim 17, wherein the digital zooming apparatus reduces a central portion of the captured image and enlarges a surrounding portion thereof when the travel is detected to be in a position farthest from the subject.

21. A method of controlling a photographic print system, comprising:
capturing a photographic image of a subject present within a photographic space, said photographic means further transmitting optical zooming data having a multiplying factor;
outputting said photographic image to a print sheet;
digitally enlarging and/or reducing captured images based on the multiplying factor; and
displaying digitally enlarging and/or reducing captured images.

22. The method according to claim 21, wherein the step of digitally enlarging/reducing captured images further comprises enlarging a central portion of the captured image and reducing a surrounding portion thereof when the multiplying factor is smallest.

23. The method according to claim 21, wherein the step of digitally enlarging/reducing captured images further comprises reducing a central portion of the captured image and enlarging a surrounding portion thereof when the multiplying factor is largest.

24. An executable computer program, stored in a computer-readable medium, said program causing a processor to execute the steps of:
moving a photographic apparatus towards or away from a subject;
detecting movement and placement of the photographic apparatus during a predetermined period of time; and
transmitting a communication to the subject if it is determined that the photographic apparatus has not been moved at the expiration of the predetermined period of time.

25. An executable computer program, stored in a computer-readable medium, said program causing a processor to execute the steps of:
moving a photographic apparatus towards or away from a subject;
detecting the travel of the photographic apparatus;
acquiring an image from said photographic apparatus; and
performing digital zoom processing on said image, wherein said digital zoom processing is performed on the basis of the detected travel.

26. The computer program according to claim 25, further comprising the step of displaying the digitally processed image.

27. The computer program according to claim 25, wherein the digital zooming processing enlarges a central portion of the captured image and reduces a surrounding portion thereof when the travel is detected to be in a position closest from the subject.

28. The computer program according to claim 25, wherein the digital zooming apparatus reduces a central portion of the captured image and enlarges a surrounding portion thereof when the travel is detected to be in a position farthest from the subject.

29. An executable computer program, stored in a computer-readable medium, said program causing a processor to execute the steps of:
capturing a photographic image of a subject present within a photographic space;
transmitting optical zooming function having a multiplying factor;
outputting said photographic image to a print sheet;
digitally enlarging and/or reducing captured images based on the multiplying factor; and
displaying digitally enlarging and/or reducing captured images.

30. The computer program according to claim 29, wherein the step of digitally enlarging/reducing captured images further comprises enlarging a central portion of the captured image and reducing a surrounding portion thereof when the multiplying factor is smallest.

31. The computer program according to claim 29, wherein the step of digitally enlarging/reducing captured images further comprises reducing a central portion of the captured image and enlarging a surrounding portion thereof when the multiplying factor is largest.

32. A print sheet apparatus, used in a photographic printing system, comprising:
photographic means for capturing photographic images of a subject present within a photographic space;
image output means for preparing said photographic images for printing to a respective print sheet, each print sheet having identification data associated with it;
identification means for reading the identification data from each print sheet and confirming that identification data matches for each print sheet; and
image print means for outputting photographic images that have been confirmed to a print sheet.
